(19) United States
(12) Patent Application Publication
(10) Pub. No.: US 2020/0386993 A1
(43) Pub. Date: Dec. 10, 2020

(54) Freeform Prism and Head-Mounted Display with Increased Field of View

(71) Applicant: Arizona Board of Regents on Behalf of the University of Arizona, Tucson, AZ (US)

(72) Inventors: Hong Hua, Tucson, AZ (US); Hekun Huang, Tucson, AZ (US)

(21) Appl. No.: 16/491,842

(22) PCT Filed: Mar. 6, 2018
(86) PCT No.: PCT/US2018/021098

§ 371 Date: Sep. 6, 2019

Related U.S. Application Data
(60) Provisional application No. 62/469,104, filed on Mar. 9, 2017.

(51) Int. Cl. G02B 27/01; G02B 5/04; G02B 17/08; G02B 3/00; G02B 25/00

(52) U.S. Cl. CPC G02B 27/0172; G02B 5/04; G02B 2027/0123; G02B 3/0006; G02B 25/001; G02B 17/086

(57) ABSTRACT

Freeform waveguide prism with compound surface and use with head-mounted light field display with integral imaging and relay group.

### RELATED APPLICATIONS

This application claims the benefit of priority of U.S. Provisional Application No. 62/469,104, filed on Mar. 9, 2017, the entire contents of which application are incorporated herein by reference.

### GOVERNMENT LICENSE RIGHTS

This invention was made with government support under Grant No. 1422653 awarded by the NSF. The government has certain rights in the invention.

### FIELD OF THE INVENTION

The present invention relates generally to the field of head-mounted displays, and more particularly, but not exclusively to head-mounted displays based on integral imaging (InI).

### BACKGROUND

Head-mounted displays (HMD), also commonly known as near-to-eye displays (NED) or head-worn displays (HWD), have gained significant interest in recent years and stimulated tremendous efforts to push the technology forward for a broad range of consumer applications. For instance, a lightweight optical see-through HMD (OST-HMD), which enables optical superposition of digital information onto a user's direct view of the physical world and maintains see-through vision to the real-world, is one of the key enabling technologies to augmented reality (AR) applications. A wide field-of-view (FOV), immersive HMD, which immerses a user in computer-generated virtual world or a high-resolution video capture of a remote real-world, is a key enabling technology to virtual reality (VR) applications. HMDs find a myriad of applications in gaming, simulation and training, defense, education, and other fields.

Despite the high promises and the tremendous progress made recently toward the development of both VR and AR displays, minimizing visual discomfort involved in wearing HMDs for an extended period remains an unresolved challenge. One of the key contributing factors to visual discomfort is the vergence-accommodation conflicts (VAC) due to the lack of the ability to render correct focus cues, including accommodation cue and retinal image blur effects. The VAC problem in HMDs stems from the fact that the image source is mostly a 2D flat surface located at a fixed distance from the eye. FIG. 1 shows a schematic layout of a typical monocular HMD, which mainly includes a 2D microdisplay as the image source and an eyepiece that magnifies the image rendered on the microdisplay and forms a virtual image appearing at a fixed distance from the eye. An OST-HMD requires an optical combiner (e.g. beamsplitter) placed in front of the eye to combine the optical paths of the virtual display and real scene. The conventional HMDs, whether monocular or binocular, see-through or immersive, lack the ability to render correct focus cues for the digital information which may appear at other distances than that corresponding to the virtual image plane. As a result, conventional HMDs fail to stimulate natural eye accommodation response and retinal blurry effects. The problem of lacking correct focus cues in HMDs causes several visual cue conflicts. For instance, a conventional stereoscopic HMD stimulates the perception of 3D space and shapes from a pair of two-dimensional (2D) perspective images, one for each eye, with binocular disparities and other pictorial depth cues of a 3D scene seen from two slightly different viewing positions. Therefore, conventional stereoscopic HMDs force an unnatural decoupling of the accommodation and convergence cues. The cue for the accommodation depth is dictated by the depth of the 2D image plane while the convergence depth of the 3D scene is dictated by the binocular disparities rendered by the image pair. The retinal image blurring cues for virtual objects rendered by the display is mismatched from those created by the natural scene. Many studies have provided strong supportive evidence that these conflicting visual cues related to incorrectly rendered focus cues in conventional HMDs may contribute to various visual artifacts and degraded visual performance.

Several approaches proposed previously may overcome the drawbacks of conventional stereoscopic displays, including volumetric displays, super-multi-view auto-stereoscopic displays, Integral-Imaging-based displays, holographic displays, multi-focal-plane displays, and computational multi-layer displays. Due to their enormous hardware complexity, many of these different display methods are not suitable for implementation in HMD systems. On the other hand, the multi-focal-plane display, integral-imaging, and computational multi-layer approaches are commonly referred to be light field displays and are suitable for head-mounted applications. Their use in HMDs is referred to as head-mounted light field displays.

Head-mounted light field displays render a true 3D scene by sampling either the projections of the 3D scene at different depths or the directions of the light rays apparently emitted by the 3D scene and viewed from different eye positions. They are capable of rendering correct or nearly correct focus cues and addressing the vergence-accommodation mismatch problem in conventional VR and AR displays. For instance, an integral imaging (InI) based display reconstructs the light fields of a 3D scene by angularly sampling the directions of the light rays apparently emitted by the 3D scene and viewed from different eye positions. As illustrated in FIG. 2, a simple InI-based display typically includes a display panel and a 2D array which can be a microlens array (MLA) or pinhole array. The display renders a set of 2D elemental images, each of which represents a different perspective of a 3D scene. The conical ray bundles emitted by the corresponding pixels in the elemental images intersect and integrally create the perception of a 3D scene that appears to emit light and occupy the 3D space. The InI-based display using 2D arrays allows the reconstruction of a 3D shape with full-parallax information in both horizontal and vertical directions, which is its main difference from the conventional auto-stereoscopic displays with only horizontal parallax using one-dimensional parallax barriers or cylindrical lenticular lenses. Since its publication by Lippmann in 1908, the InI-based technique has been widely explored for both capturing the light fields of real scenes and for its use in eyewear-free auto-stereoscopic displays. It has been known for its limitations in low lateral and longitudinal resolutions, narrow depth of field (DOF), and narrow view angle. Compared with all other non-stereoscopic 3D display techniques, the simple optical architecture of an InI technique makes it attractive to integrate with HMD optical system and create a wearable light field display.

However, like other integral-imaging based display and imaging technologies, the current InI-based HMD method suffers from several major limitations: (1) narrow field of view (<30° diagonally); (2) low lateral resolution (about 10 arc minutes in the visual space); (3) low longitudinal resolution (about 0.5 diopters in the visual space); (4) narrow depth of field (DOF) (about 1 diopter for a 10-arc minute resolution criteria); (5) limited eyebox for crosstalk-free viewing (<5 mm); and (6) limited resolution of viewing angle (>20 arc minutes per viewing). These limitations not only create significant barriers for adopting the technologies as high-performance solutions, but also potentially undermine the effectiveness of the technology for addressing the accommodation-convergence discrepancy problem.

Thus, the present disclosure details methods, design and embodiment of a high-performance head-mounted light field display based on integral imaging that overcomes some aspects of the performance limits of the state of the art summarized above.

### SUMMARY

In response to the challenges described above, in one of its aspects the present invention provides a high-performance HMD based on integral imaging that offers high lateral and longitudinal resolutions, large depth of field, cross-talk free eyebox, and increased viewing angle resolution. To this end, the present invention may provide a freeform waveguide prism, comprising: a first freeform optical surface disposed to receive and refract light into the body of the prism; a second freeform optical surface disposed to receive the refracted light from the first freeform optical surface and reflect the light into the body of the prism to provide an intermediate image within the body of the prism; and a compound freeform optical surface. The compound freeform optical surface may include an upper freeform optical surface connected to the second freeform optical surface and disposed such that light from the first freeform optical surface does not impinge thereon, and a lower freeform optical surface connected to the upper freeform optical surface, with the upper freeform optical surface disposed between the lower and second freeform optical surfaces. A third freeform optical surface may be disposed to receive the light from the intermediate image and total internally reflect the light into the body of the prism. The lower freeform optical surface may be disposed to receive the reflected light from the third freeform optical surface and reflect the light back to the third freeform surface at an angle that allows the light to exit the prism. The upper freeform optical surface may be disposed such that light from the third freeform optical surface does not impinge thereon, and the slopes of the upper and lower freeform optical surfaces may be equal at the location where such surfaces intersect. The second freeform optical surface may be configured to total internally reflect the light into the body of the prism, and the third freeform optical surface may be configured to total internally reflect the light from the second freeform optical surface into the body of the prism. For an orthogonal X-Y-Z coordinate system, the Z-axis may be along the viewing direction, the Y-axis may be parallel to the horizontal direction aligned with interpupilary direction of a user, and the X-axis may be in the vertical direction aligning with the head orientation of the user. The freeform waveguide prism may be symmetric about the horizontal (Y-Z) plane, and the freeform optical surfaces may be decentered along the horizontal Y-axis and rotated about the vertical X-axis.

In addition, the present invention may provide a head-mounted display integral imaging (InI) system, comprising: a microscopic InI unit (micro-InI) configured to create light fields of a selected 3D scene at a selected position along an optical axis of the system; a relay unit having a vari-focal element (VFE) disposed therein, the relay unit disposed on the optical axis at a location so the selected position is an optical conjugate of the relay unit, the relay unit configured to receive the light fields created by the microscopic InI unit; and the freeform waveguide prism for receiving light from the relay unit to provide an image of the 3D scene at an exit pupil of the system for viewing by a user of the head-mounted display system. The VFE may be configured to tune the location of the intermediate image within the body of the prism. The microscopic InI unit (micro-InI) may be configured to reproduce full-parallax light fields of a 3D scene having a constrained viewing zone. The relay unit may include a first lens group and the VFE may be located at a back focal length of the first lens group. The field of view of the system may be independent of the optical power of the VFE, and the VFE may be disposed on the optical axis at a location such that the compound optical power of the relay unit is maintained constant, independent of the optical power of the VFE. The microscopic InI unit may include a microdisplay and the subtended field angle of the microdisplay through the freeform waveguide prism may be maintained constant, independent of the optical power of the VFE. The focal length of the freeform waveguide prism may be 27.5 mm, the diagonal field of view of the system may be 35°, and the system may have an optical resolution as high as 2 arc minutes per pixel.

### BRIEF DESCRIPTION OF THE DRAWINGS

The foregoing summary and the following detailed description of exemplary embodiments of the present invention may be further understood when read in conjunction with the appended drawings, in which:

FIG. 1 schematically illustrates a conventional, monocular HMD in which an eyepiece magnifies the image rendered on a microdisplay and forms a virtual display appearing at a fixed, far distance from the eye;

FIG. 2 schematically illustrates a near-eye light field display based on integral imaging;

FIG. 3A schematically illustrates an exemplary configuration of a high-performance InI-based head-mounted light field display in accordance with the present invention;

FIG. 3B schematically illustrates an exemplary configuration of a micro-InI unit in accordance with the present invention;

FIGS. 4A-4D schematically illustrate an exemplary configuration of a micro-InI unit in accordance with the present invention constructed to provide ray direction control by using: an aperture array (FIG. 4A), programmable spatial light modulator (FIG. 4B), a display source with controllable directional emissions engine (FIG. 4C); and a backlight source with a spatial light modulator as an exemplary controllable directional emissions engine (FIG. 4D);

FIG. 5 schematically illustrates an exemplary configuration of a relay group in accordance with the present invention with a VFE (vari-focal element) placed at a position conjugate to the exit pupil of the eyepiece;

FIGS. 6A-6D schematically illustrate an exemplary configuration of an optical see-through InI-HMD design in accordance with the present invention using a freeform waveguide prism where part of the vari-focal relay group is incorporated into the eyepiece, with FIG. 6A showing the display path layout, FIG. 6B showing the see-through view layout, FIG. 6C showing a segmented rear surface of the waveguide prism for extended see-through view, and FIG. 6D showing a front view of the rear surface of the waveguide prism;

FIGS. 7A, 7B schematically illustrate an exemplary configuration of 2D optical layout of an InI-HMD design configuration in accordance with the present invention, with FIG. 7A showing the light field display path and FIG. 7B the see-through path;

FIGS. 8A, 8B illustrate MTF (modulation transfer function) plots for the reconstruction central depth plane (CDP) depth of 3 diopters for fields on-axis (FIG. 8A) and for fields for the furthest MLA (micro lens array) element near the edge of the MLA (FIG. 8B);

FIGS. 9A, 9B illustrate MTF plots for the reconstruction CDP depth of 2 diopters for fields on-axis to the MLA (FIG. 9A) and fields for the furthest MLA element near the edge of the MLA (FIG. 9B);

FIGS. 10A, 10B illustrate MTF plots for the reconstruction CDP depth of 0 diopters for fields on-axis to the MLA (FIG. 10A) and for fields for the furthest MLA element near the edge of the MLA (FIG. 10B);

FIGS. 11A, 11B illustrate MTF plots for the reconstruction points shifted away from CDP by 0.25 diopters for fields on-axis to the MLA (FIG. 11A) and for fields for the furthest MLA element near the edge of the MLA (FIG. 11B);

FIGS. 12A, 12B illustrate MTF plots for the reconstruction points shifted away from CDP by 0.5 diopters for fields on-axis to the MLA (FIG. 12A) and for fields for the furthest MLA element near the edge of the MLA (FIG. 12B);

FIGS. 13A, 13B illustrate MTF plots for the reconstruction points shifted away from CDP by 0.75 diopters for fields on-axis to the MLA (FIG. 13A) and for fields for the furthest MLA element near the edge of the MLA (FIG. 13B);

FIGS. 14A, 14B illustrate MTF plots for the reconstruction points shifted away from CDP by 1 diopter for fields on-axis to the MLA (FIG. 14A) and for fields for the furthest MLA element near the edge of the MLA (FIG. 14B); and

FIG. 15 illustrates the MTF for the see-through path FOV 65°×40°.

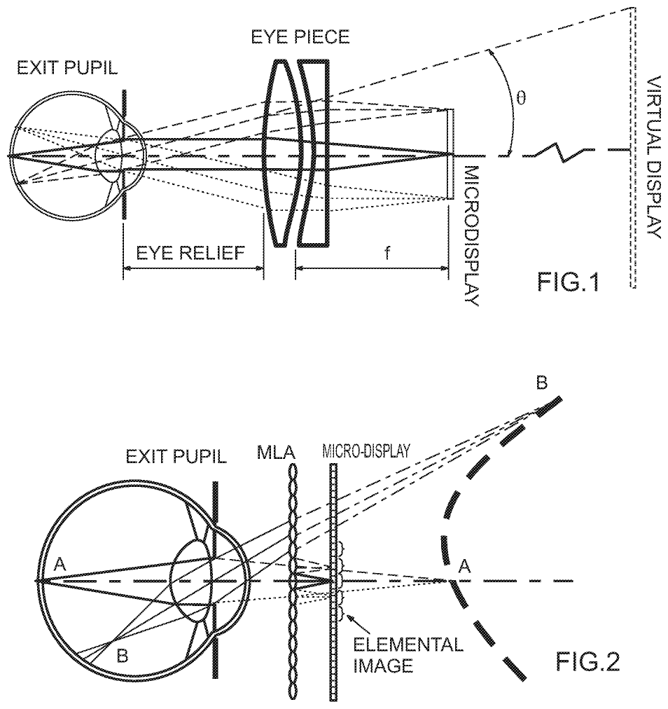

### DETAILED DESCRIPTION

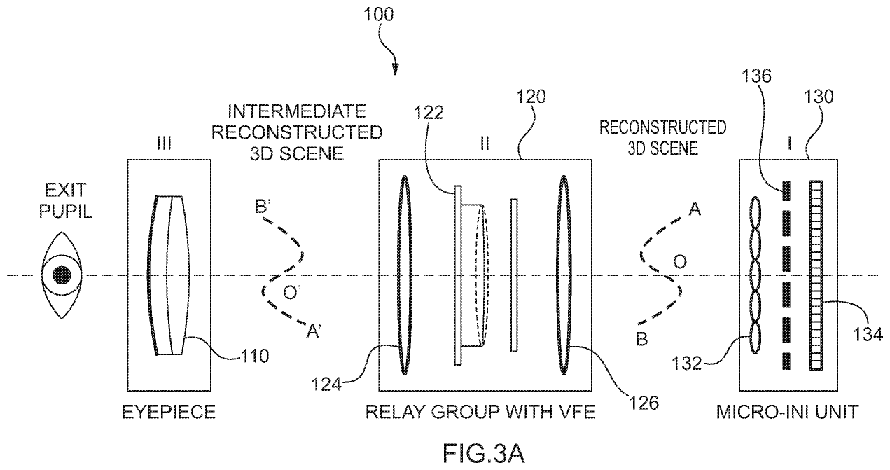

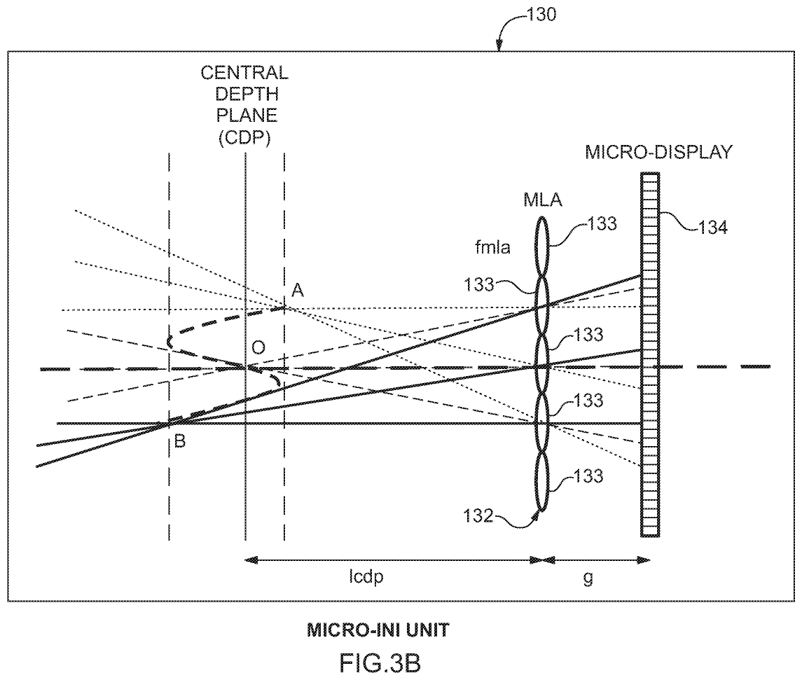

Referring now to the figures, wherein like elements are numbered alike throughout, as shown in FIG. 3A, a HMD system 100 in accordance with the present invention may include three key subsystems: I) a microscopic InI unit (micro-InI) 130, II) a relay group 120 with a vari-focal element (VFE) 122 disposed therein for receiving the light fields from the InI unit 130, and III) eyepiece optics 110 for receiving the tuned intermediate 3D scene from the relay group 120. As illustrated in FIG. 3B, the micro-InI unit 130 can reproduce the full-parallax light fields of a 3D scene seen from a constrained viewing zone, where the full-parallax light fields offer the change of view perspectives of a 3D scene from both horizontal and vertical viewing directions. The constrained viewing zone optically corresponds to limiting the aperture of the micro-InI unit 130, and the constrained viewing zone is optically conjugate to the exit pupil of the display system 100 where a viewer's eye is placed to view the reconstructed 3D scene. The relay group 120 creates an intermediate image of the 3D scene reconstructed by the micro-InI unit 130 with a tunable position of its central depth plane (CDP). Depending on the magnification power of the eyepiece 110, the position of the CDP may be tunable in the range from about 0.5 mm to as large as hundreds of millimeters to create the perception of a 3D scene with a large depth range spanning from the optical infinity (0 diopter) to as close as 20 cm (5 diopters). The relay group 120 may also facilitate the flip of the concavity of the reconstructed 3D scene AOB. The eyepiece optics 110 reimages the tunable 3D light fields into a viewer's eye and enlarges the tunable depth range of the 3D light fields into a large depth volume spacing from meters far to as close as a few centimeters. A see-through unit (not shown), which may be optics with a beamsplitter function, may optically communicate with the eyepiece optics 110 to optically enable non-obtrusive view of a real-world scene if a see-through view is desired. The micro-InI unit 130 of FIG. 3A, as further illustrated in FIG. 3B, may include a high-resolution microdisplay and a micro-lens array (MLA) 132. The focal length of the lenslets 133 in the MLA 132 is denoted as f_{MLA} and the gap between the microdisplay 134 and the MLA 132 is noted as g. A set of 2D elemental images, each representing a different perspective of a 3D scene AOB, may be displayed on the high-resolution microdisplay 134. Through the MLA 132, each elemental image works as a spatially-incoherent object and the conical ray bundles emitted by the pixels in the elemental images intersect and integrally create the perception of a 3D scene that appears to emit light and occupy the 3D space. The central depth plane (CDP) of the reconstructed miniature scene, with a depth range of z₀, is located by the distance l_{cdp} measured from the MLA 132. Such an InI system 130 allows the reconstruction of a 3D surface shape AOB with parallax information in both horizontal and vertical directions. The light field of the reconstructed 3D scene (i.e., the curve AOB in FIG. 3B) may be optically coupled into eyepiece optics 110 via the relay group 120 for viewing by a user. In a resolution priority InI system (f_{MLA}≠g), the central depth plane CDP of the reconstructed 3D scene is optically conjugate to the microdisplay 134 and its location is given by

l_{cdp}=gM_{MLA}, (1)

Where M_{MLA} is the magnification of the micro-InI unit 130, which may be expressed by

$${M}_{MLA} = \frac{{f}_{MLA}}{g - {f}_{MLA}} . \qquad ( 2 )$$

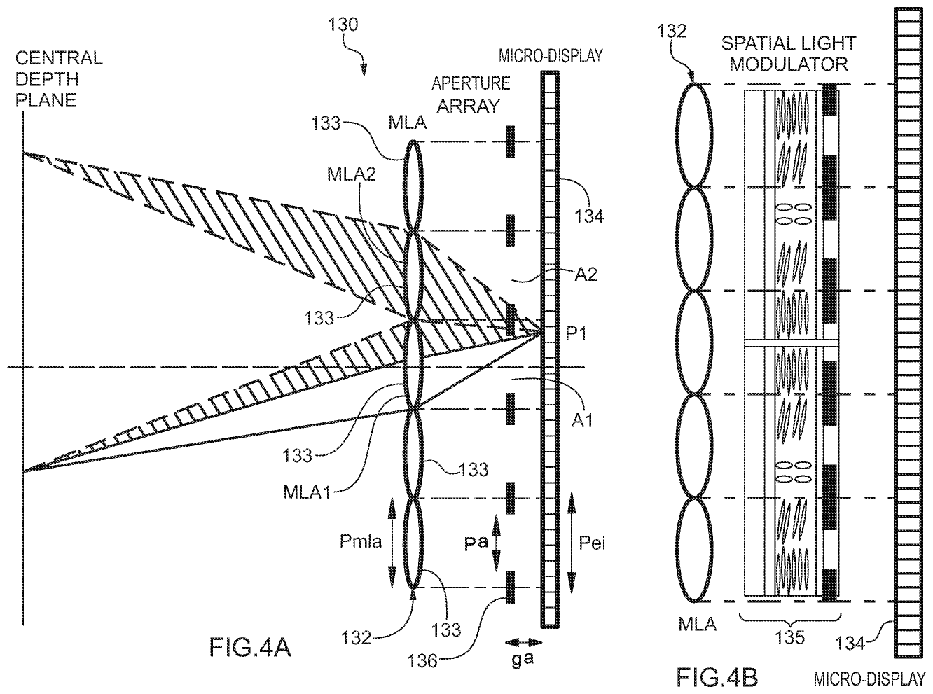

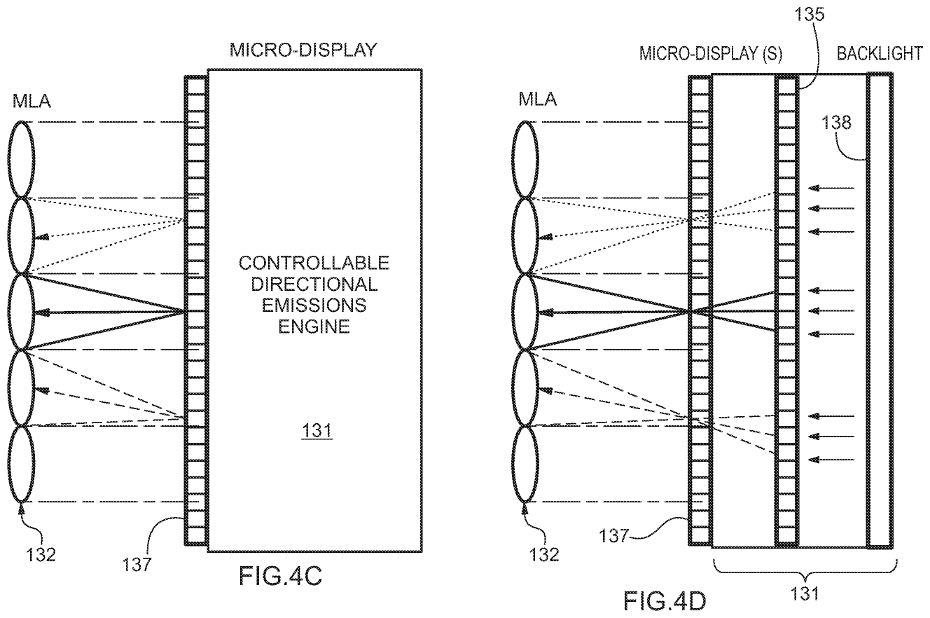

As shown in FIGS. 3A, 4A, optionally, an aperture array 136, including a group of ray-limiting apertures that matches the pitch of the MLA 132, may be inserted between the microdisplay 134 and MLA 132. The small aperture corresponding to each microlens 133 allows rays within the designed viewing window to propagate through the optics and reach the eyebox while blocking unwanted rays from reaching an adjacent microlens 133 or while blocking rays from neighboring elemental images to reach a microlens 133. For instance, the black zone between the aperture A1 and A2 blocks the dashed rays originated from point P1 from reaching the MLA2 adjacent to the lenslet MLA1. These blocked rays are typically the main source of view cross-talk and ghost images observed in an InI display system. The distance from the microdisplay 134 to the aperture array 136 is denoted as gₐ and the diameter of aperture opening is denoted as pₐ, which may be constrained by

$$\begin{matrix}{g}_{a} \leq {g}_{a \text{-} max} = g \frac{{p}_{ei}}{{p}_{ei} + {p}_{mla}} , & ( 3 ) \\ {p}_{a} \leq {p}_{a \text{-} max} = {p}_{ei} \frac{( {g}_{a \text{-} max} - {g}_{a} )}{{g}_{a \text{-} max}} , & ( 4 )\end{matrix}$$

Where gₐ₋ₘₐₓ and pₐ₋ₘₐₓ are the maximum allowable gap and aperture size, respectively, pₑᵢ is the dimension of the elemental image, and pₘₗₐ is the pitch of the MLA 132.

One drawback in using an aperture array 136 with a fixed aperture size is that it can partially block rays for pixels located near the edge of each elemental images if the size of the elemental image changes. As illustrated in FIG. 4A, a small part of the rays from point P1 which are supposed to propagate through lenslet MLA1 are blocked by the black zone between aperture A1 and aperture A2, causing vignetting-like effects such that viewer may observe reduction of image brightness for points near the edge of each elemental images. FIG. 4B shows an alternative configuration to that of FIG. 4A in which the aperture array 136 is replaced by a programmable spatial light modulator (SLM) 135 so that the size and shape of each aperture can be dynamically adapted to avoid partially blocking desired rays. FIG. 4C shows another embodiment of a micro-InI unit in accordance with the present invention in which the microdisplay 134 and aperture array 136 are replaced by a display source 131 with controllable directional emissions, where the light emission direction can be controlled precisely so that the rays from each pixel will only reach their corresponding MLA lenslet 133. FIG. 4D demonstrates one possible configuration of such display source 131 where a spatial light modulator 135 is inserted between a backlight source 138 with non-direction emission and non-self-emissive microdisplay 137. The spatial light modulator 135 may be set to program and control the cone angle of the rays that illuminate the microdisplay 137 and reach the MLA 132.

A conventional InI-based display system can typically suffer from a limited depth of field (DOF) due to the rapid degradation of spatial resolution as the depths of 3D reconstruction points shift away from that of the CDP. For instance, the 3D scene volume may need to be limited to less than 0.5 diopters in order to maintain a spatial resolution of 3 arc minutes or better in the visual space. In order to render a much larger 3D scene volume while maintaining a high spatial resolution, such as in the exemplary configuration of FIG. 3A, a relay group 120 with an electronically-controlled vari-focal element 122 sandwiched inside is inserted between the micro-InI 130 and the eyepiece 110. Exemplary VFE's 122 include liquid lenses, liquid crystal lenses, deformable mirrors, or any other tunable optical technology, such as electrically tunable optical technology. By dynamically controlling the optical power, φ_{R}, of the relay group 120 by applying different voltages to the VFE 122, the relay group 120 forms an intermediate image A′O′B′ of the reconstructed miniature 3D scene created by the micro-InI 130. The central depth position CDP of the relayed intermediate scene is tunable axially (along the optical axis) with respect to the eyepiece 110. As a result, the depth volume of the magnified 3D virtual scene by the eyepiece 110 can be shifted axially from very close (e.g. 5 diopters) to very far (e.g. 0 diopter) while maintaining high lateral and longitudinal resolutions.

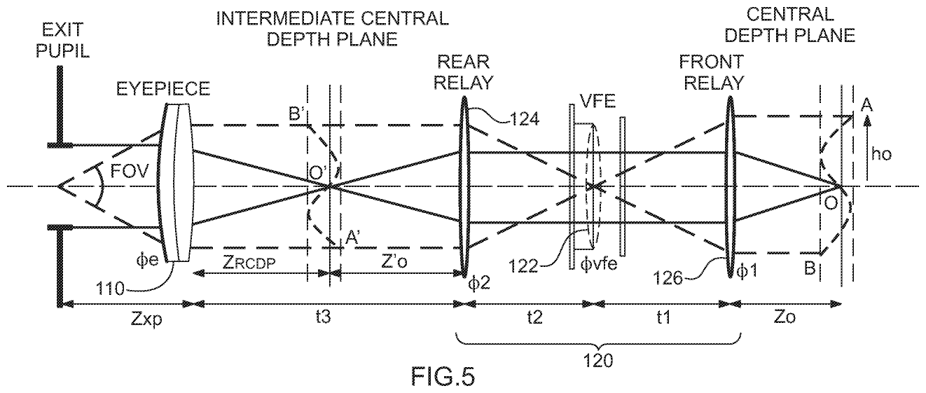

FIG. 5 schematically illustrates an exemplary configuration of the vari-focal relay group 120, such as the relay group 120 of FIG. 3A, including a front lens group “Front Relay” 126 adjacent to the micro-InI unit 130, VFE optics 122 located in the middle functioning as the system stop, and rear lens group “Rear Relay” 124 adjacent to the eyepiece 110. The compound power, φ_{R}, of the relay group 120 is given by

φ_{R}=φ₁+φ₂+φ_{vfe}−φ₁φ₂(t₁+t₂)−φ_{vfe}(φ₁t₁+φ₂t₂)+φ_{vfe}φ₁φ₂t₁t₂ (4)

Where φ₁, φ_{VFE}, and φ₂ are the optical power of the front lens group 126, VFE 122, and the rear lens group 124, respectively. t₁ and t₂ are the spaces between the front lens group 126 and VFE 122 and between the VFE 122 and the rear lens group 124. z₀ is the axial distance between the front lens group and the 3D scene reconstructed by the micro-InI unit 130. The axial position of the relayed intermediate scene is given by

$${z}_{0}^{′} = - \frac{1}{\frac{( 1 - {z}_{0} {ϕ}_{1} ) - [ {z}_{0} + ( 1 - {z}_{0} {ϕ}_{1} ) {t}_{1} ] {ϕ}_{vfe}}{\begin{matrix}[ {z}_{0} + ( 1 - {z}_{0} {ϕ}_{1} ) {t}_{1} ] + \\ \{ ( 1 - {z}_{0} {ϕ}_{1} ) - [ {z}_{0} + ( 1 - {z}_{0} {ϕ}_{1} ) {t}_{1} ] {ϕ}_{vfe} \} {t}_{2}\end{matrix}} - {ϕ}_{2}} \qquad ( 5 )$$

The lateral magnification of the vari-focal relay system is given by

$${M}_{R} = \frac{1}{\begin{matrix}( 1 - {z}_{0} {ϕ}_{1} ) - [ {z}_{0} + ( 1 - {z}_{0} {ϕ}_{1} ) {t}_{1} ] {ϕ}_{vfe} - \\ \{ [ {z}_{0} + ( 1 - {z}_{0} {ϕ}_{1} ) {t}_{1} ] + [ ( 1 - {z}_{0} {ϕ}_{1} ) - \\ [ {z}_{0} + ( 1 - {z}_{0} {ϕ}_{1} ) {t}_{1} ] {ϕ}_{vfe} ] {t}_{2} \} {ϕ}_{2}\end{matrix}} \qquad ( 6 )$$

Assuming φₑ is the optical power of the eyepiece 110 and Z_{RCDP} is the distance from the relayed CDP to the eyepiece 110, the apparent CDP position of the reconstructed 3D virtual scene through the eyepiece 110 is given by

$${z}_{RCDP}^{′} = \frac{1}{{ϕ}_{e} - \frac{1}{{z}_{RCDP}}} \qquad ( 7 )$$

The lateral magnification of the entire system through the eyepiece 110 is given by

$${M}_{t} = \vert {M}_{MLA} \cdot {M}_{R} \cdot \frac{z {′}_{RCDP}}{{z}_{RCDP}} \vert \qquad ( 8 )$$

The field of view (FOV) of the entire system through the eyepiece 110 is given by, FOV=

$$2 {tan}^{- 1} \frac{{h}_{0}}{\begin{matrix}[ {h}_{vfe} + ( {u}_{vfe} - {h}_{vfe} {ϕ}_{vfe} ) {t}_{1} ] + \{ ( {u}_{vfe} - \\ {h}_{vfe} {ϕ}_{vfe} ) - [ {h}_{vfe} + ( {u}_{vfe} - {h}_{vfe} {ϕ}_{vfe} ) {t}_{1} ] {ϕ}_{1} \} {z}_{0}\end{matrix}} \qquad ( 9 )$$

Where t₃ is the spacing between the eyepiece 110 and rear relay lens 124; zₓₚ is the spacing between the exit pupil and the eyepiece 110; h₀ is the image height of the reconstructed scene, and we further define u_{vfe}=[(1×zₓₚφₑ)−(zₓₚ+(1−zₓₚφₑ)t₃)φ₂], and h_{vfe}=[(1−zₓₚφₑ)−(zₓₚ+(1−zₓₚφₑ)t₃)φ₂]−[(zₓₚ+(1−zₓₚφₑ)t₃)φ₂+((1−zₓₚφₑ)−(zₓₚ+(1−zₓₚφₑ)t₃)φ₂)]t₂.

When the VFE 122 is set to be an optical conjugate to the exit pupil of the eyepiece 110 ((i.e. h_{vfe}=0) where the entrance pupil of the eye is placed to view the display 134, we have h_{vfe}=0 and the FOV is independent of the optical power of the VFE 122. The equation in Eq. (9) is simplified into:

$$FOV = 2 {tan}^{- 1} \frac{{h}_{0}}{{u}_{vfe} {t}_{1} + [ {u}_{vfe} - {u}_{vfe} {t}_{1} {ϕ}_{1} ] {z}_{0}} \qquad ( 10 )$$

As illustrated in FIG. 5, a preferred embodiment of the vari-focal relay group 120 is the placement of the VFE 122 at the back focal length of the front relay group 26 (i.e. t₁=1/φ₁) to make the VFE 122 an optical conjugate to the exit pupil of the eyepiece 110 ((i.e. h_{vfe}=0). With this preferred embodiment, the compound power, φR, of the relay group 120 given by Eq. (4) is simplified into:

φ_{R}=Φ₁−φ₁φ₂t₂ (11)

The lateral magnification of the vari-focal relay system given by Eq. (6) is simplified into

$${M}_{R} = \frac{1}{( 1 - {z}_{0} {ϕ}_{R} ) - \frac{{ϕ}_{vfe} ( 1 - {ϕ}_{2} {t}_{2} ) + {ϕ}_{2} ( 1 + {ϕ}_{1} {t}_{2} )}{{ϕ}_{1}}} \qquad ( 12 )$$

And so does the lateral magnification of the entire system given by Eq. (8).

When t₁=1/φ₁ and h_{vfe}=0, the FOV of the system is further simplified into

$$FOV = 2 {tan}^{- 1} \frac{{h}_{0} {ϕ}_{1}}{{u}_{vfe}} \qquad ( 13 )$$

As demonstrated by Eqs. (10) through (13), the careful position of the VFE 122 in the preferred manner ensures that the compound optical power of the relay group 120 is maintained constant, independent of the optical power of the VFE 122 due to constant chief ray directions owing to the property of object-space telecentricity. As further demonstrated by Eq. (13), the subtended field angle of the display through the eyepiece 110 is further maintained constant, independent of the optical power of the VFE 122. Maintaining a constant optical power for the relay group 120 helps the virtually reconstructed 3D scene achieve constant field of view regardless of the focal depths of the CDP. Therefore a much larger volume of a 3D scene could be visually perceived without seams or artifacts in a gaze-contingent or time-multiplexing mode. It is worth noting that the lateral magnification of the relay group 120 given by Eq. (12) can be further maintained constant if t₂=1/φ₂ is satisfied, which makes the vari-focal relay group 120 a double-telecentric system.

The eyepiece 110 in FIG. 3A can take many different forms. For instance, to achieve a compact optical design of an optical see-through HMD, a wedge-shaped freeform prism can be adopted, through which the 3D scene reconstructed by the micro-InI unit 130 and relay group 120 is magnified and viewed. To enable see-through capability for AR systems, a freeform corrector lens with one of the surfaces coated with beamsplitter coating can be attached to the freeform prism eyepiece to correct the viewing axis deviation and undesirable aberrations introduced by the freeform prism to the real-world scene.

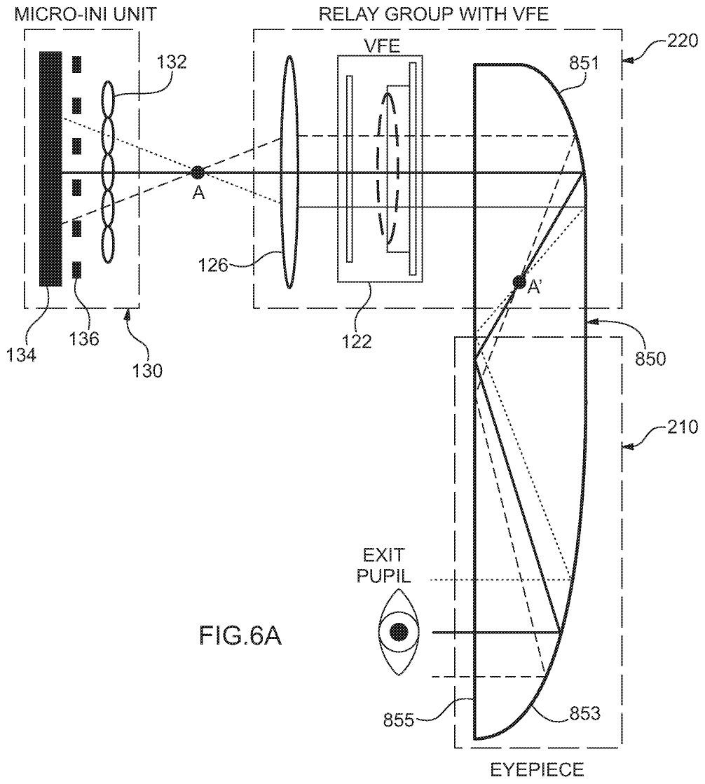

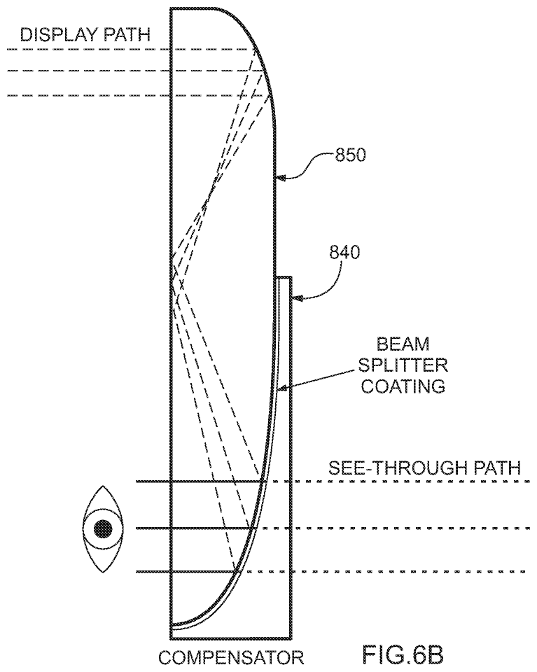

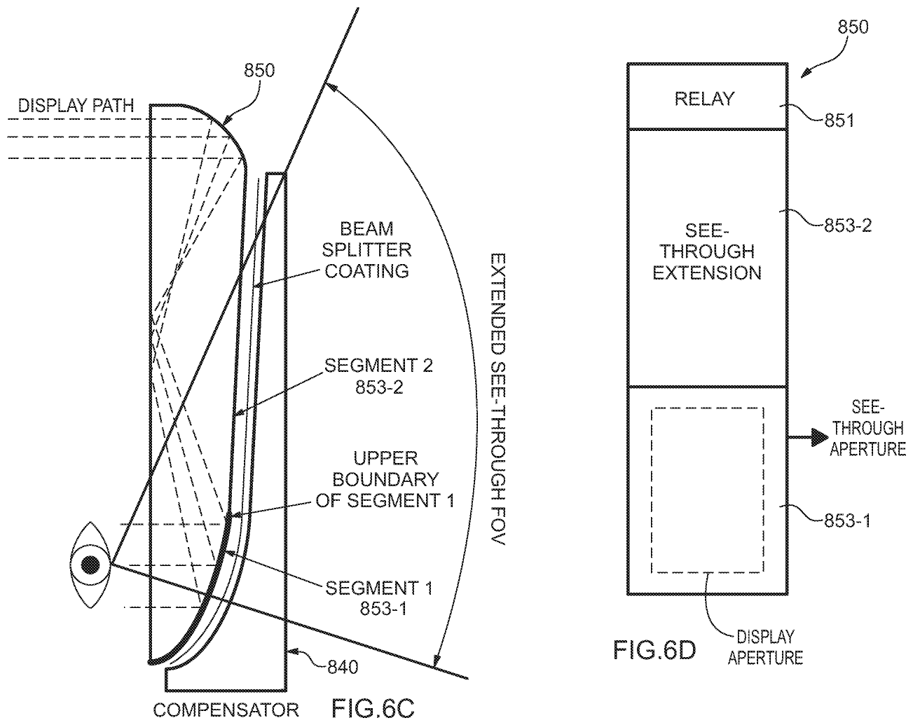

In another aspect of the present invention, part of the relay group 120 may be incorporated into the eyepiece optics 110, such as freeform eyepiece, such that the tunable intermediate 3D scene is formed inside the freeform eyepiece. In such a context, the eyepiece may be a wedge-shaped freeform waveguide prism, for example. FIG. 6A schematically illustrates the concept of a freeform waveguide-like prism 850 formed by multiple freeform optical surfaces. The exit pupil is located where the use's eye is placed to view the magnified 3D scene. In the design, part of a traditional relay group 220 following the VFE 122 is incorporated into the prism 850 and fulfilled by the top portion 851 of the freeform waveguide prism 850 contained within the box labeled “Relay Group with VFE.” A light ray emitted from a 3D point (e.g. A) is first refracted by a closest optical element 126 of the relay group 220 and transmitted into the prism 850, followed by a reflection by one or multiple freeform surfaces to create an intermediate image (e.g. A′). The axial position of the intermediate image (e.g. A′) is tunable by the VFE 122. Multiple consecutive reflections by the subsequent surfaces and a final refraction through the exit surface 855 allow the ray reaching the exit pupil of the system. Multiple bundles of rays from different elemental images may exist, but do so apparently from the same object point, each of which bundles represents a different view of the object, impinging on different locations of the exit pupil. These ray bundles integrally reconstruct a virtual 3D point (e.g. “A”) located in front of the eye. Rather than requiring multiple optical elements, the optical path is naturally folded within a multi-surface prism 850, which helps reduce the overall volume and weight of the optics substantially when compared with designs using rotationally symmetric elements. Compared with a design using a traditional wedge-shaped 3-surface prism, the waveguide-like eyepiece design incorporates part of the relay function, enabling a much more compact system than combining a standalone relay group 120 with a 3-surface prism. Besides the advantage of compactness, the waveguide-like multi-fold eyepiece design offers a much more favorable form factor, because it enables the ability to fold the remaining relay group and micro-InI unit horizontally to the temple sides. The multiple folding not only yields a much more weight-balanced system, but also enables a substantially larger see-through FOV than using a wedge-shaped prism.

To enable see-through capability for AR systems, the bottom part 853 of the rear surface, marked as the eyepiece portion, of the prism 850 in FIG. 6A can be coated as a beamsplitting mirror, and a freeform corrector lens 840 including at least two freeform optical surfaces, may be attached to the rear surface of the prism 850 to correct the viewing axis deviation and undesirable aberrations introduced by the freeform prism 850 to the real-world scene. The see-through schematic layout is shown in FIG. 6B. The rays from the virtual light field are reflected by the rear surface of the prism 850 while the rays from a real-world scene are transmitted through the freeform corrector lens 840 and prism 850. The front surface of the freeform corrector lens 840 matches the shape of the rear surface of the prism 850. The back surface of the freeform corrector lens 840 may be optimized to minimize the shift and distortion introduced to the rays from a real-world scene when the lens is combined with the prism 850. The additional corrector lens “compensator” does not noticeably increase the footprint and weight of the overall system. In another aspect of the present invention, the bottom part 853 of the rear surface, marked as the eyepiece portion, of the prism 850 in FIG. 6A may be divided into two segments, the segment 853-1 and the segment 853-2. As schematically illustrated in FIG. 6C, the segment of 853-1 may be a reflective or partial reflective surface which receives the light fields generated by the micro-InI unit. A beamsplitting mirror coating on the segment of 853-1 also allows the transmission of the light rays from a real-world scene. The segment 853-2 is a transmissive or semi-transmissive surface which only receives the light rays from a real-world scene, while it does not receive the light fields generated by the micro-InI unit 130. FIG. 6D schematically illustrates a front view of the rear surface of the prism 850. The two surface segments, 853-1 and 853-2, intersect at an upper boundary of the aperture window required to receive the reconstructed 3D light fields by the micro-InI unit 130, and they may be made by two separate freeform surfaces. The division of the bottom part of the rear surface 853 into two separate segments 853-1, 853-2 with different light paths provides the ability to substantially enlarge the FOV of the see-through view beyond the FOV of the display path without being subject to the constraints of the virtual display path. As shown in FIG. 6C, a freeform corrector lens 840 may be attached to the rear surface of the prism 850 to correct the viewing axis deviation and undesirable aberrations introduced by the freeform prism 850 to the real-world scene. The rays from the virtual light field are reflected by the segment 853-1 of the rear surface of the prism 850 while the rays from a real-world scene are transmitted through both the segments 853-1 and 853-2 of the prism 850 and the freeform corrector lens 840. The surface segment 853-2 may be optimized to minimize visual artifacts of see-through view when it is combined with the freeform corrector lens 840. The front surface of the freeform corrector lens 840 matches the shape of the surface segments 853-1 and 853-2 of the prism 850. The back surface of the freeform corrector lens 840 may be optimized to minimize the shift and distortion introduced to the rays from a real-world scene when the freeform corrector lens 840 is combined with the prism 850.

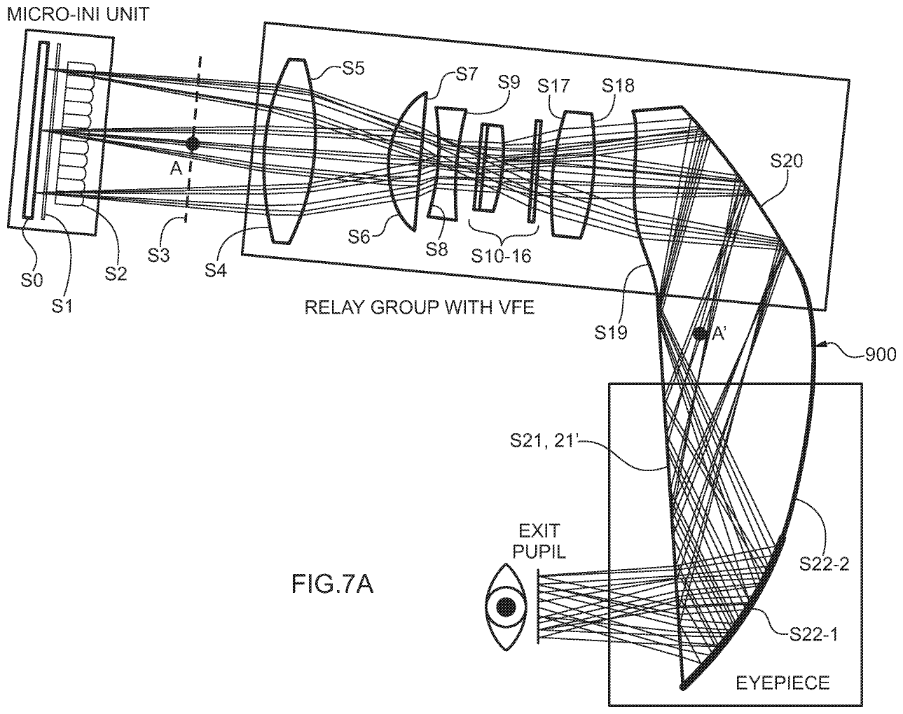

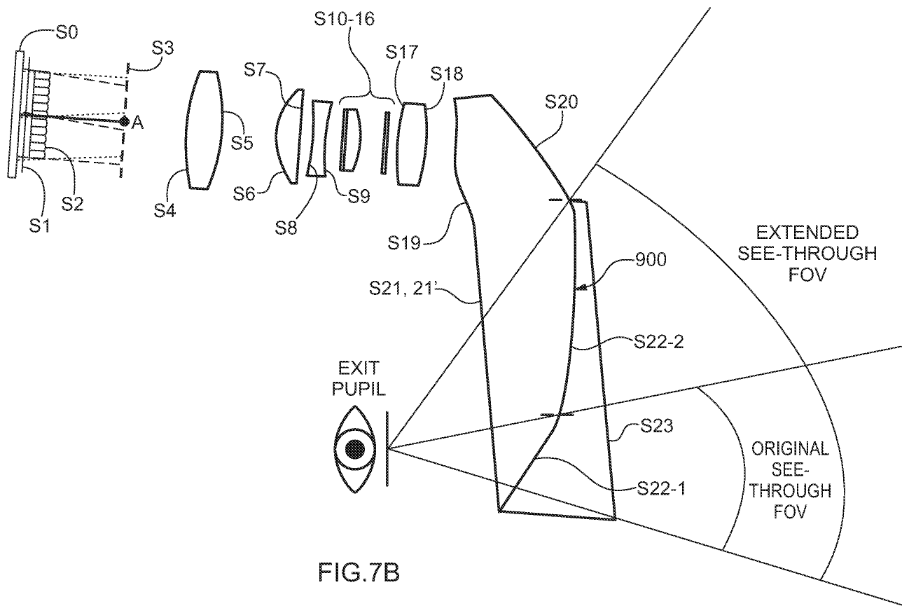

In accordance with yet another aspect of the present invention, FIG. 7A schematically illustrates an optical design of a physical system that embodies the conceptual system of FIG. 6A. FIG. 7A illustrates the 2D optical layout of the light field display path, and FIG. 7B shows the optical layout of the see-through path. The optical system of the light field display includes a micro-InI unit, a relay group with VFE, and a freeform waveguide. A part of the relay group may be incorporated into the waveguide. The Micro-InI unit may include a microdisplay S0, a pinhole array S1, and a microlens array S2. The relay group may include four lenses, a commercially available VFE (Electrical Lens EL 10-30 by Optotune Inc.), and two freeform surfaces (Surface S19 and S20). The freeform waveguide prism 900 may be formed by multiple freeform optical surfaces which are labeled as S19, S20, S21, and S22, respectively. In the design, part of a traditional relay group following the VFE may be incorporated into the prism 900 and fulfilled by the Surface S19 and S20. A light ray emitted from a 3D point (e.g. A) is first refracted by the surface S19 of the prism 900, followed by a reflection by the surface S20 to create an intermediate image (e.g. A′). The axial position of the intermediate image (e.g. A′) is tunable by the VFE. Two more consecutive reflections by the surfaces S21′ and S22-1 and a final refraction through the surface S21 allow the ray to reach the exit pupil of the system. There exist multiple bundles of rays from different elemental images but apparently from the same object point, each of which represents a different view of the object, impinging on different locations of the exit pupil. These ray bundles integrally reconstruct a virtual 3D point located in front of the eye. The rays reflected by the Surface S21′ of the waveguide are required to satisfy the condition of total internal reflection. The rear surfaces S22-1, S22-2 of the prism 900 may be coated with a mirror coating for building an immersive HMD system which blocks the view of the real-world scene. Alternatively, the surface S22-1 may be coated with a beamsplitting coating if optical see-through capability is desired using the auxiliary lens, as shown in FIG. 7B.

It should be noted that in the design disclosed hereby the Z-axis is along the viewing direction, the Y-axis is parallel to the horizontal direction aligning with interpupilary direction, and the X-axis is in the vertical direction aligning with the head orientation. As a result, the overall waveguide system is symmetric about the horizontal (YOZ) plane, and the optical surfaces (S19, S20, S21, and S22) are decentered along the horizontal Y-axis and rotated about the vertical X-axis. The optical path is folded in the horizontal YOZ plane. This arrangement allows the micro-InI unit and the vari-focal relay group to be mounted on the temple side of the user's head, resulting in a balanced and ergonomic system packaging.

Table 1 highlighted some of the key performance specifications for the system of FIG. 7A. The system offers the ability to render the true 3D light field of a 3D scene which subtends a diagonal FOV of 35° and achieves an optical resolution as high as 2 arc minutes per pixel in the visual space. Furthermore, the system offers a large depth range, tunable from 0 to 5 diopters, with a high longitudinal resolution of about 0.1 diopters for a monocular display. Moreover, the system achieves a high view density of about 0.5/mm², where the view density, σ, is defined as the number of unique views per unit area on the exit pupil, given by:

$$σ = \frac{N}{{A}_{XP}}$$

where N is the total number of views and A_{XP} is the area of the exit pupil of the display system. A view density of 0.5/mm² is equivalent to a viewing angle resolution of approximately 1 arc minute for objects at distance of 0.2 diopters. The exit pupil diameter for crosstalk-free viewing, also known as the eyebox of the display, is about 6 mm. In this embodiment, the exit pupil diameter is limited by the aperture size of the commercial VFE and it can be increased if another larger-aperture VFE 15 adopted. Finally, the system offers a large see-through FOV, greater than 65° horizontally and 40° vertically. The microdisplay utilized in our prototype is a 0.7″ organic light emitting display (OLED) with an 8 μm color pixel and pixel resolution of 1920×1080 (ECX335A by Sony). The optics design itself, however, is able to support OLED panels of different dimensions or other type of microdisplays such as liquid crystal displays that have a color pixel size greater than 6 μm.

TABLE 1
First-order system specifications

| Tunable depth range of central | 0~5 diopters |
|---|---|
| depth plane (CDP) | |
| Field of view (Virtual Display) | 35° (diagonal), or 30.5° |
| | (Horizontal) × 17.5° (Vertical) at CDP |
| Field of view (See-through) | >75° (diagonal), or >65° |
| | (Horizontal) × 40° (Vertical) |
| Focal length of front relay group | 24 mm |
| Focal length of rear relay group | 24 mm |
| Focal range of the tunable lens | 75-100 mm (8.5 diopters) |
| Eyepiece focal length, feye | 27.5 mm |
| Exit pupil diameter | 6 mm |
| Pitch of the lenslet in MLA | 1 mm |
| F-number of the MLA | 3.3 |

An exemplary implementation of the system of FIG. 7A is provided, Tables 2 through 5, in form of the optical surface data. Table 2 summarizes the basic parameters of the display path (units: mm). Tables 3 through 5 provide the optimized coefficients defining the non-spherical optical surfaces.

TABLE 2
Optical specifications of the InI-HMD display path

| Element | | | | | | |
|---|---|---|---|---|---|---|
| number | Surface | Surface | | | | Refract |
| or name | No. | Type | Y Radius | Thickness | Material | Mode |
| Aperture | | Sphere | Infinity | 2.215 | | Refract |
| MLA | S1 | Asphere | −5.32 | 3 | PMMA | Refract |
| | S2 | Asphere | −1.48 | 13.833 | | Refract |
| | S3 | Sphere | Infinity | 10.547 | | Refract |
| Front | S4 | Sphere | 35.09 | 6.6 | NBK7_SCHOTT | Refract |
| relay | S5 | Sphere | −35.09 | 9.970 | | Refract |
| group | S6 | Sphere | 12.92 | 4.3 | NBK7_SCHOTT | Refract |
| | S7 | Sphere | Infinity | 2.457 | | Refract |
| | S8 | Sphere | −39.78 | 2.5 | NSF11_SCHOTT | Refract |
| | S9 | Sphere | 39.78 | 1.75 | | Refract |
| VFE | S10 | Sphere | Infinity | 1.15 | | Refract |
| | S11 | Sphere | Infinity | 0.5 | BK7_SCHOTT | Refract |
| | S12 | Sphere | Infinity | 2.758 | ‘OL1024’ | Refract |
| | S13 | Sphere | −28.5714 | 4.492 | | Refract |
| | S14 | Sphere | Infinity | 0.5 | BK7_SCHOTT | Refract |
| | S15 | Sphere | Infinity | 1.15 | | Refract |
| | S16 | Sphere | Infinity | 1 | | Refract |
| Lens | S17 | Sphere | 40.67 | 5.3 | NBK7_SCHOTT | Refract |
| | S18 | Sphere | −40.67 | 0 | | Refract |
| Waveguide | S19 | XY | 31.04167 | 0 | PMMA | Refract |
| | | Polynomial | | | | |
| | S20 | XY | −54.2094 | 0 | PMMA | Reflect |
| | | Polynomial | | | | |
| | S21 | XY | −145.276 | 0 | PMMA | Reflect |
| | | Polynomial | | | | |
| | S22 | XY | −47.3572 | 0 | PMMA | Reflect |
| | | Polynomial | | | | |
| | S21′ | XY | −145.276 | 0 | | Refract |
| | | Polynomial | | | | |

A high resolution microdisplay with pixels as small as 6 μm is adopted to achieve a high resolution virtual reconstructed 3D image. To achieve such high-resolution imaging for the micro-InI unit, a microlens array (MLA) formed by aspherical surfaces may specifically be designed. Each of the aspherical surfaces of the MLA may be described as,

$$z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} , \qquad ( 14 )$$

where z is the sag of the surface measured along the z-axis of a local x, y, z coordinate system, c is the vertex curvature, r is the radial distance, k is the conic constant, A through E are the 4th, 6th, 8th, 10th and 12th order deformation coefficients, respectively. The material of the MLA is PMMA. Table 3 provides the coefficients for the surfaces S1 and S2.

TABLE 3
Aspherical surface definitions for microlens array (MLA)

| | S1 | S2 |
|---|---|---|
| Y Radius | −5.32 | −1.48 |
| Conic Constant (K) | 30 | −0.809 |
| 4th Order Coefficient (A) | −0.157 | −0.013 |
| 6th Order Coefficient (B) | −0.092 | 0.002 |

To enable enlarged see-through FOV, the freeform waveguide prism 900 may be formed by five freeform surfaces, labeled as surface S19, S20, S21/S21′, S22-1, and S22-2, respectively. The freeform corrector lens may be formed by two freeform surfaces, in which the front surface shares the same surface specifications as the surfaces S22-1 and S22-2 of the waveguide prism 900 and the rear surface is denoted as surface S23. The surface segment of S22-1 is a reflective or partial reflective surface which receives the light fields generated by the micro-InI unit. A beamsplitting mirror coating on the segment of S22-1 also allows the transmission of the light rays from a real-world scene for see-through capability. The surface segment S22-2 is a transmissive or semi-transmissive surface which only receives the light rays from a real-world scene, while it does not receive the light fields generated by the micro-InI unit.

The freeform surfaces, including S19, S20, S21/S21′, S22-1, and S23 may be described mathematically as

$$z = \frac{{cr}^{2}}{1 + \sqrt{1 - ( 1 + k ) {c}^{2} {r}^{2}}} + {\sum }_{j = 2}^{66} {C}_{j} {x}^{m} {y}^{n} j = \frac{{( m + n )}^{2} + m + 3 n}{2} + 1 , \qquad ( 15 )$$

where z is the sag of the free-form surface measured along the z-axis of a local x, y, z coordinate system, c is the vertex curvature (CUY), r is the radial distance, k is the conic constant, and Cⱼ is the coefficient for x^{m}y^{m}. The material for both the waveguide prism and compensation lens is PMMA. Tables 4 through 8 provide the coefficients for the surfaces S19 through S21, S22-1, and S23, respectively, and Table 9 provides the surface references of each optical surface.

During the design process, the specifications for the Surface segment S22-1 were obtained after the optimization of the light field display path through the prism 900 composed of the micro-InI unit, the relay lens group, and the surfaces S19. S20, S21/21′, and S22-1. The required aperture dimensions of Surfaces S20 and S22-1 were determined first for the light field display path. Then Surfaces S20, S21 and S22-1 were imported into 3D modeling software such as Solidworks® from which the Surface S22-2 was created. The shape of the Surface S22-2 was created in the modeling software by satisfying the following requirements: (1) it intersects with Surface S22-1 along or above the upper boundary line of the required aperture for surface S22-1 defined by the display path; (2) along the intersection line between the surface S22-2 and S22-2, the surface slopes at the intersection points on the surface S22-2 approximately match, if not equal, with those corresponding points on the surface S22-1 to ensure the two surfaces to appear to be nearly continuous, which minimizes visual artifacts to the see-through view when it is combined with a matching freeform corrector lens; (3) the Surface S22-2 intersects with the surface S20 along or below the lower boundary line of the required aperture for surface S20, defined by the display path; and (4) the overall thickness between the surface S21 and S22-2 is minimized. Finally, a freeform shape of the Surface S22-2 is obtained in the 3D modeling software which is combined with the surfaces S19, S20, S21/21′, and S22-1 to create an enclosed freeform waveguide prism. FIG. 7B demonstrated a substantially enlarged see-through FOV through the method described above.

TABLE 4
Surface definition for freeform surface S19

| | |
|---|---|
| Y Radius | 31.0417 |
| Y Curvature | 3.2215e−2 |
| Conic Constant (SCO K \| C1) | −30 |
| X (SCO X \| C2) | 0 |
| Y (SCO Y \| C3) | 0 |
| X**2 (SCO X2 \| C4) | −0.0181749 |
| X * Y (SCO XY \| C5) | 0 |
| Y**2 (SCO Y2 \| C6) | −0.03201 |
| X**3 (SCO Y3 \| C7) | 0 |
| X**2 * Y (SCO X2Y \| C8) | −0.002337 |
| XY**2 (SCO XY2 \| C9) | 0 |
| Y**3 (SCO Y3 \| C10) | −0.00340584 |
| X**4 (SCO X4 \| C11) | 2.214179429e−005 |
| X**3 * Y (SCO X3Y \| C12) | 0 |
| X**2 * Y**2 (SCO X2Y2 \| C13) | −8.34173481e−005 |
| X* Y**3 (SCO XY3 \| C14) | 0 |
| Y**4 (SCO Y4 \| C15) | −0.00012019 |
| X**5 (SCO X5 \| C16) | 0 |
| X**4 * Y (SCO X4Y \| C17) | −1.9551358e−006 |
| X**3 * Y**2 (SCO X3Y2 \| C18) | 0 |
| X**2 * Y**3 (SCO X2Y3 \| C19) | −5.7523828e−007 |
| X* Y**4 (SCO XY4 \| C20) | 0 |
| Y**5 (SCO Y5 \| C21) | −2.18978576e−006 |
| X**6 (SCO X6 \| C22) | −1.08276112e−007 |
| X**5 * Y (SCO X5Y \| C23) | 0 |
| X**4 * Y**2 (SCO X4Y2 \| C24) | −3.584137e−007 |
| X**3 * Y**3 (SCO X3Y3 \| C25) | 0 |
| X**2 * Y**4 (SCO X2Y4 \| C26) | 9.1214167e−008 |
| X* Y**5 (SCO XY5 \| C27) | 0 |
| Y**6 (SCO Y6 \| C28) | −5.28011679e−009 |
| X**7 (SCO X7 \| C29) | 0 |
| X**6 * Y (SCO X6Y \| C30) | 0 |
| X**5 * Y**2 (SCO X5Y2 \| C31) | 0 |
| X**4 * Y**3 (SCO X4Y3 \| C32) | 0 |
| X**3 * Y**4 (SCO X3Y4 \| C33) | 0 |
| X**2 * Y**5 (SCO S2Y5 \| C34) | 0 |
| X* Y**6 (SCO XY6 \| C35) | 0 |
| Y**7 (SCO Y7 \| C36) | 0 |
| X**8 (SCO X8 \| C37) | 0 |
| X**7 * Y (SCO X7Y \| C38) | 0 |
| X**6 * Y**2 (SCO X6Y2 \| C39) | 0 |
| X**5 * Y**3 (SCO X5Y3 \| C40) | 0 |
| X**4 * Y**4 (SCO X4Y4 \| C41) | 0 |
| X**3 * Y**5 (SCO X3Y5 \| C42) | 0 |
| X**2 * Y**6 (SCO X2Y6 \| C43) | 0 |
| X* Y**7 (SCO XY7 \| C44) | 0 |
| Y**8 (SCO Y8 \| C45) | 0 |
| X**9 (SCO X9 \| C46) | 0 |
| X**8 * Y (SCO X8Y \| C47) | 0 |
| X**7 * Y**2 (SCO X7Y2 \| C48) | 0 |
| X**6 * Y**3 (SCO X6Y3 \| C49) | 0 |
| X**5 * Y**4 (SCO X5Y4 \| C50) | 0 |
| X**4 * Y**5 (SCO X4Y5 \| C51) | 0 |
| X**3 * Y**6 (SCO X3Y6 \| C52) | 0 |
| X**2 * Y**7 (SCO X2Y7 \| C53) | 0 |
| X*Y**8 (SCO XY8 \| C54) | 0 |
| Y**9 (SCO Y9 \| C55) | 0 |
| X**10 (SCO X10 \| C56) | 0 |
| X**9 * Y (SCO X9Y \| C57) | 0 |
| X**8 * Y**2 (SCO X8Y2 \| C58) | 0 |
| X**7 * Y**3 (SCO X7Y3 \| C59) | 0 |
| X**6 * Y**4 (SCO X6Y4 \| C60) | 0 |
| X**5 * Y**5 (SCO X5Y5 \| C61) | 0 |
| X**4 * Y**6 (SCO X4Y6 \| C62) | 0 |
| X**3 * Y**7 (SCO X3Y7 \| C63) | 0 |
| X**2 * Y**8 (SCO X2Y8 \| C64) | 0 |
| X* Y**9 (SCO XY9 \| C65) | 0 |
| Y**10 (SCO Y10 \| C66) | 0 |

TABLE 5
Surface definition for freeform surface S20

| | |
|---|---|
| Y Radius | −54.2094 |
| Y Curvature | −1.845e−2 |
| Conic Constant (SCO K \| C1) | −13.0997 |
| X (SCO X \| C2) | 0 |
| Y (SCO Y \| C3) | 0 |
| X**2 (SCO X2 \| C4) | 0.0011699 |
| X * Y (SCO XY \| C5) | 0 |
| Y**2 (SCO Y2 \| C6) | 0.00676927 |
| X**3 (SCO Y3 \| C7) | 0 |
| X**2 * Y (SCO X2Y \| C8) | −4.52710486e−005 |
| X Y**2 (SCO XY2 \| C9) | 0 |
| Y**3 (SCO Y3 \| C10) | −0.00011081 |
| X**4 (SCO X4 \| C11) | −1.1510996e−005 |
| X**3 * Y (SCO X3Y \| C12) | 0 |
| X**2 * Y**2 (SCO X2Y2 \| C13) | −9.13752747e−006 |
| X * Y**3 (SCO XY3 \| C14) | 0 |
| Y**4 (SCO Y4 \| C15) | −5.5289301e−006 |
| X**5 (SCO X5 \| C16) | 0 |
| X**4 * Y (SCO X4Y \| C17) | −8.8179807e−007 |
| X**3 * Y**2 (SCO X3Y2 \| C18) | 0 |
| X**2 * Y**3 (SCO X2Y3 \| C19) | −1.06187669e−006 |
| X * Y**4 (SCO XY4 \| C20) | 0 |
| Y**5 (SCO Y5 \| C21) | −3.38263553e−007 |
| X**6 (SCO X6 \| C22) | 4.77710263e−008 |
| X**5 * Y (SCO X5Y \| C23) | 0 |
| X**4 * Y**2 (SCO X4Y2 \| C24) | 6.21915481e−008 |
| X**3 * Y**3 (SCO X3Y3 \| C25) | 0 |
| X**2 * Y**4 (SCO X2Y4 \| C26) | 1.43552488e−007 |
| X * Y**5 (SCO XY5 \| C27) | 0 |
| Y**6 (SCO Y6 \| C28) | 5.362211474e−008 |
| X**7 (SCO X7 \| C29) | 0 |
| X**6 * Y (SCO X6Y \| C30) | 1.193262499e−008 |
| X**5 * Y**2 (SCO X5Y2 \| C31) | 0 |
| X**4 * Y**3 (SCO X4Y3 \| C32) | −6.01716948e−009 |
| X**3 * Y**4 (SCO X3Y4 \| C33) | 0 |
| X**2 * Y**5 (SCO S2Y5 \| C34) | −8.19603928e−009 |
| X * Y**6 (SCO XY6 \| C35) | 0 |
| Y**7 (SCO Y7 \| C36) | −2.505270966e−009 |
| X**8 (SCO X8 \| C37) | −8.149026e−010 |
| X**7 * Y (SCO X7Y \| C38) | 0 |
| X**6 * Y**2 (SCO X6Y2 \| C39) | −1.84757517e−010 |
| X**5 * Y**3 (SCO X5Y3 \| C40) | 0 |
| X**4 * Y**4 (SCO X4Y4 \| C41) | 2.388128888e−010 |
| X**3 * Y**5 (SCO X3Y5 \| C42) | 0 |
| X**2 * Y**6 (SCO X2Y6 \| C43) | 1.61835037e−010 |
| X * Y**7 (SCO XY7 \| C44) | 0 |
| Y**8 (SCO Y8 \| C45) | 3.966177607e−011 |
| X**9 (SCO X9 \| C46) | 0 |
| X**8 * Y (SCO X8Y \| C47) | 0 |
| X**7 * Y**2 (SCO X7Y2 \| C48) | 0 |
| X**6 * Y**3 (SCO X6Y3 \| C49) | 0 |
| X**5 * Y**4 (SCO X5Y4 \| C50) | 0 |
| X**4 * Y**5 (SCO X4Y5 \| C51) | 0 |
| X**3 * Y**6 (SCO X3Y6 \| C52) | 0 |
| X**2 * Y**7 (SCO X2Y7 \| C53) | 0 |
| X * Y**8 (SCO XY8 \| C54) | 0 |
| Y**9 (SCO Y9 \| C55) | 0 |
| X**10 (SCO X10 \| C56) | 0 |
| X**9 * Y (SCO X9Y \| C57) | 0 |
| X**8 * Y**2 (SCO X8Y2 \| C58) | 0 |
| X**7 * Y**3 (SCO X7Y3 \| C59) | 0 |
| X**6 * Y**4 (SCO X6Y4 \| C60) | 0 |
| X**5 * Y**5 (SCO X5Y5 \| C61) | 0 |
| X**4 * Y**6 (SCO X4Y6 \| C62) | 0 |
| X**3 * Y**7 (SCO X3Y7 \| C63) | 0 |
| X**2 * Y**8 (SCO X2Y8 \| C64) | 0 |
| X * Y**9 (SCO XY9 \| C65) | 0 |
| Y**10 (SCO Y10 \| C66) | 0 |

TABLE 6
Surface definition for freeform surface S21/S21′

| | |
|---|---|
| Y Radius | −145.276 |
| Y Curvature | −6.88e−3 |
| Conic Constant (SCO K \| C1) | −1.5654 |
| X (SCO X \| C2) | 0 |
| Y (SCO Y \| C3) | 0 |
| X**2 (SCO X2 \| C4) | −0.0142277 |
| X * Y (SCO XY \| C5) | 0 |
| Y**2 (SCO Y2 \| C6) | 0.00392684 |
| X**3 (SCO Y3 \| C7) | 0 |
| X**2 * Y (SCO X2Y \| C8) | 0.000646111 |
| X Y**2 (SCO XY2 \| C9) | 0 |
| Y**3 (SCO Y3 \| C10) | 2.44041e−005 |
| X**4 (SCO X4 \| C11) | 0.000151 |
| X**3 * Y (SCO X3Y \| C12) | 0 |
| X**2 * Y**2 (SCO X2Y2 \| C13) | −8.2192e−006 |
| X * Y**3 (SCO XY3 \| C14) | 0 |
| Y**4 (SCO Y4 \| C15) | −3.028061e−007 |
| X**5 (SCO X5 \| C16) | 0 |
| X**4 * Y (SCO X4Y \| C17) | −4.13244e−006 |
| X**3 * Y**2 (SCO X3Y2 \| C18) | 0 |
| X**2 * Y**3 (SCO X2Y3 \| C19) | 2.964542e−008 |
| X * Y**4 (SCO XY4 \| C20) | 0 |
| Y**5 (SCO Y5 \| C21) | 1.127521e−009 |
| X**6 (SCO X6 \| C22) | 4.4371187e−008 |
| X**5 * Y (SCO X5Y \| C23) | 0 |
| X**4 * Y**2 (SCO X4Y2 \| C24) | 2.7676459e−008 |
| X**3 * Y**3 (SCO X3Y3 \| C25) | 0 |
| X**2 * Y**4 (SCO X2Y4 \| C26) | −3.277381e−011 |
| X * Y**5 (SCO XY5 \| C27) | 0 |
| Y**6 (SCO Y6 \| C28) | −1.4480674e−012 |
| X**7 (SCO X7 \| C29) | 0 |
| X**6 * Y (SCO X6Y \| C30) | 0 |
| X**5 * Y**2 (SCO X5Y2 \| C31) | 0 |
| X**4 * Y**3 (SCO X4Y3 \| C32) | 0 |
| X**3 * Y**4 (SCO X3Y4 \| C33) | 0 |
| X**2 * Y**5 (SCO S2Y5 \| C34) | 0 |
| X * Y**6 (SCO XY6 \| C35) | 0 |
| Y**7 (SCO Y7 \| C36) | 0 |
| X**8 (SCO X8 \| C37) | 0 |
| X**7 * Y (SCO X7Y \| C38) | 0 |
| X**6 * Y**2 (SCO X6Y2 \| C39) | 0 |
| X**5 * Y**3 (SCO X5Y3 \| C40) | 0 |
| X**4 * Y**4 (SCO X4Y4 \| C41) | 0 |
| X**3 * Y**5 (SCO X3Y5 \| C42) | 0 |
| X**2 * Y**6 (SCO X2Y6 \| C43) | 0 |
| X * Y**7 (SCO XY7 \| C44) | 0 |
| Y**8 (SCO Y8 \| C45) | 0 |
| X**9 (SCO X9 \| C46) | 0 |
| X**8 * Y (SCO X8Y \| C47) | 0 |
| X**7 * Y**2 (SCO X7Y2 \| C48) | 0 |
| X**6 * Y**3 (SCO X6Y3 \| C49) | 0 |
| X**5 * Y**4 (SCO X5Y4 \| C50) | 0 |
| X**4 * Y**5 (SCO X4Y5 \| C51) | 0 |
| X**3 * Y**6 (SCO X3Y6 \| C52) | 0 |
| X**2 * Y**7 (SCO X2Y7 \| C53) | 0 |
| X * Y**8 (SCO XY8 \| C54) | 0 |
| Y**9 (SCO Y9 \| C55) | 0 |
| X**10 (SCO X10 \| C56) | 0 |
| X**9 * Y (SCO X9Y \| C57) | 0 |
| X**8 * Y**2 (SCO X8Y2 \| C58) | 0 |
| X**7 * Y**3 (SCO X7Y3 \| C59) | 0 |
| X**6 * Y**4 (SCO X6Y4 \| C60) | 0 |
| X**5 * Y**5 (SCO X5Y5 \| C61) | 0 |
| X**4 * Y**6 (SCO X4Y6 \| C62) | 0 |
| X**3 * Y**7 (SCO X3Y7 \| C63) | 0 |
| X**2 * Y**8 (SCO X2Y8 \| C64) | 0 |
| X * Y**9 (SCO XY9 \| C65) | 0 |
| Y**10 (SCO Y10 \| C66) | 0 |

TABLE 7
Surface definition for freeform surface S22-1

| | |
|---|---|
| Y Radius | −47.3572012741099 |
| Y Curvature | −2.111611e−2 |
| Conic Constant (SCO K C1) | −4.32135 |
| X (SCO X \| C2) | 0 |
| Y (SCO Y \| C3) | 0 |
| X**2 (SCO X2 \| C4) | 0.000908 |
| X * Y (SCO XY \| C5) | 0 |
| Y**2 (SCO Y2 \| C6) | 0.005975 |
| X**3 (SCO Y3 \| C7) | 0 |
| X**2 * Y (SCO X2Y \| C8) | 4.66442802e−005 |
| X Y**2 (SCO XY2 \| C9) | 0 |
| Y**3 (SCO Y3 \| C10) | 0.000101981 |
| X**4 (SCO X4 \| C11) | −5.17499005e−006 |
| X**3 * Y (SCO X3Y \| C12) | 0 |
| X**2 * Y**2 (SCO X2Y2 \| C13) | −4.7451096e−006 |
| X* Y**3 (SCO XY3 \| C14) | 0 |
| Y**4 (SCO Y4 \| C15) | −2.4419368e−007 |
| X**5 (SCO X5 \| C16) | 0 |
| X**4 * Y (SCO X4Y \| C17) | −1.9769907e−007 |
| X**3 * Y**2 (SCO X3Y2 \| C18) | 0 |
| X**2 * Y**3 (SCO X2Y3 \| C19) | 3.352610999e−008 |
| X* Y**4 (SCO XY4 \| C20) | 0 |
| Y**5 (SCO Y5 \| C21) | 1.61592149e−008 |
| X**6 (SCO X6 \| C22) | 8.08067957e−009 |
| X**5 * Y (SCO X5Y \| C23) | 0 |
| X**4 * Y**2 (SCO X4Y2 \| C24) | 7.3374791e−009 |
| X**3 * Y**3 (SCO X3Y3 \| C25) | 0 |
| X**2 * Y**4 (SCO X2Y4 \| C26) | 6.611479e−009 |
| X* Y**5 (SCO XY5 \| C27) | 0 |
| Y**6 (SCO Y6 \| C28) | 9.4341645e−011 |
| X**7 (SCO X7 \| C29) | 0 |
| X**6 * Y (SCO X6Y \| C30) | 7.9369652e−010 |
| X**5 * Y**2 (SCO X5Y2 \| C31) | 0 |
| X**4 * Y**3 (SCO X4Y3 \| C32) | 6.27173598e−010 |
| X**3 * Y**4 (SCO X3Y4 \| C33) | 0 |
| X**2 * Y**5 (SCO S2Y5 \| C34) | 1.332732e−010 |
| X* Y**6 (SCO XY6 \| C35) | 0 |
| Y**7 (SCO Y7 \| C36) | −1.5647943e−011 |
| X**8 (SCO X8 \| C37) | −2.12470728e−012 |
| X**7 * Y (SCO X7Y \| C38) | 0 |
| X**6 * Y**2 (SCO X6Y2 \| C39) | 3.27745944e−011 |
| X**5 * Y**3 (SCO X5Y3 \| C40) | 0 |
| X**4 * Y**4 (SCO X4Y4 \| C41) | 1.07463864e−011 |
| X**3 * Y**5 (SCO X3Y5 \| C42) | 0 |
| X**2 * Y**6 (SCO X2Y6 \| C43) | 1.347790032e−012 |
| X * Y**7 (SCO XY7 \| C44) | 0 |
| Y**8 (SCO Y8 \| C45) | −9.599201503e−014 |
| X**9 (SCO X9 \| C46) | 0 |
| X**8 * Y (SCO X8Y \| C47) | 0 |
| X**7 * Y**2 (SCO X7Y2 \| C48) | 0 |
| X**6 * Y**3 (SCO X6Y3 \| C49) | 0 |
| X**5 * Y**4 (SCO X5Y4 \| C50) | 0 |
| X**4 * Y**5 (SCO X4Y5 \| C51) | 0 |
| X**3 * Y**6 (SCO X3Y6 \| C52) | 0 |
| X**2 * Y**7 (SCO X2Y7 \| C53) | 0 |
| X*Y**8 (SCO XY8 \| C54) | 0 |
| Y**9 (SCO Y9 \| C55) | 0 |
| X**10 (SCO X10 \| C56) | 0 |
| X**9 * Y (SCO X9Y \| C57) | 0 |
| X**8 * Y**2 (SCO X8Y2 \| C58) | 0 |
| X**7 * Y**3 (SCO X7Y3 \| C59) | 0 |
| X**6 * Y**4 (SCO X6Y4 \| C60) | 0 |
| X**5 * Y**5 (SCO X5Y5 \| C61) | 0 |
| X**4 * Y**6 (SCO X4Y6 \| C62) | 0 |
| X**3 * Y**7 (SCO X3Y7 \| C63) | 0 |
| X**2 * Y**8 (SCO X2Y8 \| C64) | 0 |
| X* Y**9 (SCO XY9 \| C65) | 0 |
| Y**10 (SCO Y10 \| C66) | 0 |

TABLE 8
Surface definition for freeform surface S23

| | |
|---|---|
| Y Radius | 149.3605 |
| Y Curvature | 6.695e−3 |
| Conic Constant (SCO K \| C1) | 9.81433 |
| X (SCO X \| C2) | 0 |
| Y (SCO Y \| C3) | 0 |
| X**2 (SCO X2 \| C4) | −0.024663 |
| X * Y (SCO XY \| C5) | 0 |
| Y**2 (SCO Y2 \| C6) | 0.0612683 |
| X**3 (SCO Y3 \| C7) | 0 |
| X**2 * Y (SCO X2Y \| C8) | 0.0010723 |
| X Y**2 (SCO XY2 \| C9) | 0 |
| Y**3 (SCO Y3 \| C10) | 2.4386556e−005 |
| X**4 (SCO X4 \| C11) | 0.00013098 |
| X**3 * Y (SCO X3Y \| C12) | 0 |
| X**2 * Y**2 (SCO X2Y2 \| C13) | −1.2892527e−006 |
| X * Y**3 (SCO XY3 \| C14) | 0 |
| Y**4 (SCO Y4 \| C15) | 2.62995523e−006 |
| X**5 (SCO X5 \| C16) | 0 |
| X**4 * Y (SCO X4Y \| C17) | −6.0819504e−006 |
| X**3 * Y**2 (SCO X3Y2 \| C18) | 0 |
| X**2 * Y**3 (SCO X2Y3 \| C19) | −1.3155971e−007 |
| X * Y**4 (SCO XY4 \| C20) | 0 |
| Y**5 (SCO Y5 \| C21) | 4.0503658e−008 |
| X**6 (SCO X6 \| C22) | 1.3439432e−007 |
| X**5 * Y (SCO X5Y \| C23) | 0 |
| X**4 * Y**2 (SCO X4Y2 \| C24) | 2.5855823e−008 |
| X**3 * Y**3 (SCO X3Y3 \| C25) | 0 |
| X**2 * Y**4 (SCO X2Y4 \| C26) | −2.699141e−008 |
| X * Y**5 (SCO XY5 \| C27) | 0 |
| Y**6 (SCO Y6 \| C28) | 5.31499927e−009 |
| X**7 (SCO X7 \| C29) | 0 |
| X**6 * Y (SCO X6Y \| C30) | −3.738121e−009 |
| X**5 * Y**2 (SCO X5Y2 \| C31) | 0 |
| X**4 * Y**3 (SCO X4Y3 \| C32) | 2.69691705e−012 |
| X**3 * Y**4 (SCO X3Y4 \| C33) | 0 |
| X**2 * Y**5 (SCO S2Y5 \| C34) | 4.84174393e−011 |
| X * Y**6 (SCO XY6 \| C35) | 0 |
| Y**7 (SCO Y7 \| C36) | −1.39752199e−010 |
| X**8 (SCO X8 \| C37) | 4.2757097e−011 |
| X**7 * Y (SCO X7Y \| C38) | 0 |
| X**6 * Y**2 (SCO X6Y2 \| C39) | 1.1630807e−011 |
| X**5 * Y**3 (SCO X5Y3 \| C40) | 0 |
| X**4 * Y**4 (SCO X4Y4 \| C41) | 3.4775484e−011 |
| X**3 * Y**5 (SCO X3Y5 \| C42) | 0 |
| X**2 * Y**6 (SCO X2Y6 \| C43) | 3.6136367e−012 |
| X * Y**7 (SCO XY7 \| C44) | 0 |
| Y**8 (SCO Y8 \| C45) | −5.8509308e−013 |
| X**9 (SCO X9 \| C46) | 0 |
| X**8 * Y (SCO X8Y \| C47) | 0 |
| X**7 * Y**2 (SCO X7Y2 \| C48) | 0 |
| X**6 * Y**3 (SCO X6Y3 \| C49) | 0 |
| X**5 * Y**4 (SCO X5Y4 \| C50) | 0 |
| X**4 * Y**5 (SCO X4Y5 \| C51) | 0 |
| X**3 * Y**6 (SCO X3Y6 \| C52) | 0 |
| X**2 * Y**7 (SCO X2Y7 \| C53) | 0 |
| X * Y**8 (SCO XY8 \| C54) | 0 |
| Y**9 (SCO Y9 \| C55) | 0 |
| X**10 (SCO X10 \| C56) | 0 |
| X**9 * Y (SCO X9Y \| C57) | 0 |
| X**8 * Y**2 (SCO X8Y2 \| C58) | 0 |
| X**7 * Y**3 (SCO X7Y3 \| C59) | 0 |
| X**6 * Y**4 (SCO X6Y4 \| C60) | 0 |
| X**5 * Y**5 (SCO X5Y5 \| C61) | 0 |
| X**4 * Y**6 (SCO X4Y6 \| C62) | 0 |
| X**3 * Y**7 (SCO X3Y7 \| C63) | 0 |
| X**2 * Y**8 (SCO X2Y8 \| C64) | 0 |
| X * Y**9 (SCO XY9 \| C65) | 0 |
| Y**10 (SCO Y10 \| C66) | 0 |

TABLE 9
Definition of the local surface references in the global coordinate system

| | Origin of surface reference | | | Orientation of the surface |
|---|---|---|---|---|
| | X (mm) | Y (mm) | Z (mm) | Rotation about X-axis θ (°) |
| Surface S19 | 0 | 4.912722 | 5.374900 | 2.588056 |
| Surface S20 | 0 | −5.688113 | 25.091300 | 36.309581 |
| Surface S21 | 0 | −128.220891 | 77.884058 | 18.362678 |
| Surface S22-1 | 0 | −35.523862 | 76.539845 | −13.778904 |
| Surface S23 | 0 | −82.2906 | 81.8565 | 82.6660 |

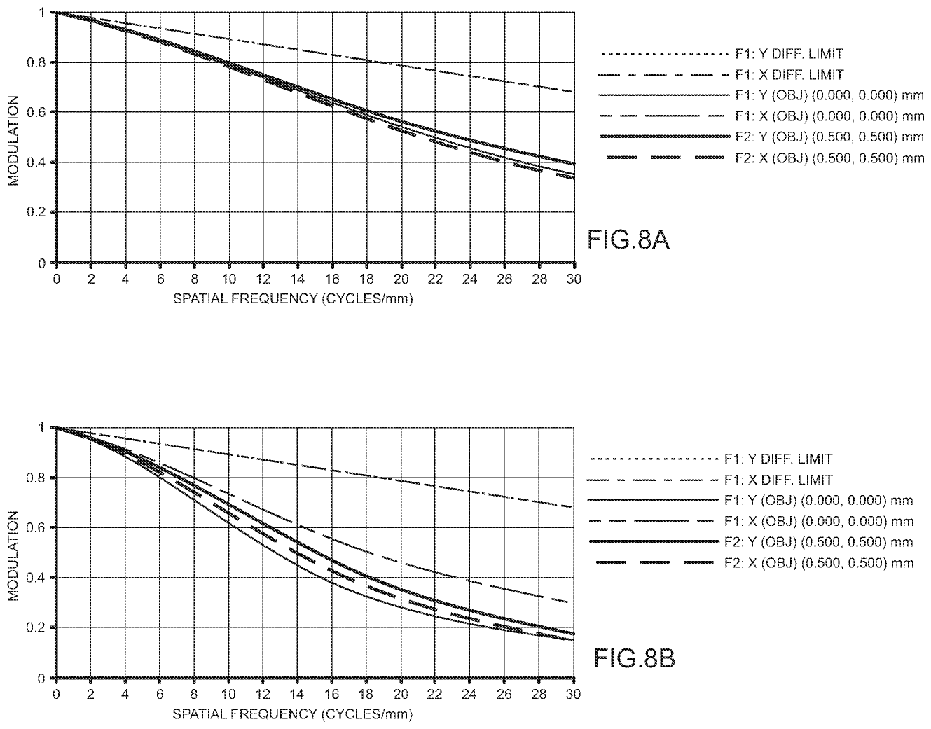

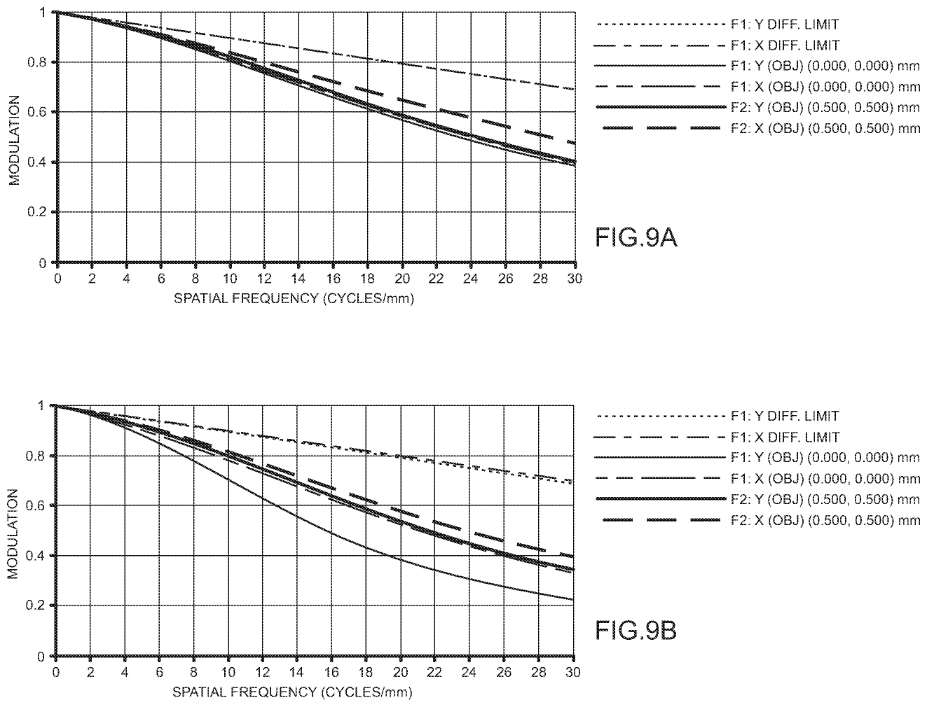

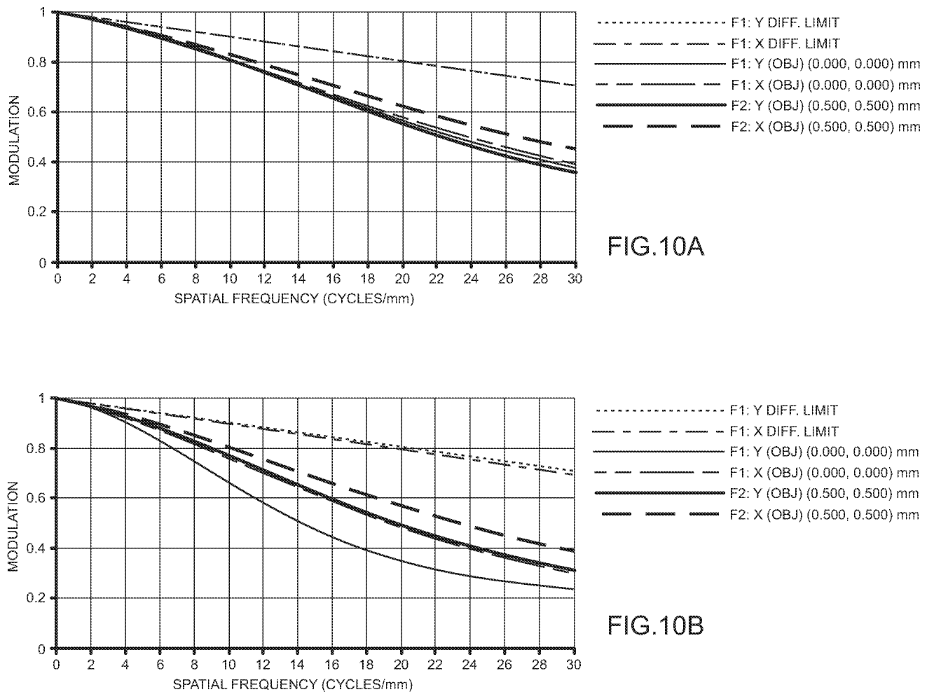

During the design process, three representative wavelengths, 465 nm, 550 nm, and 630 nm were selected which correspond to the peak emission spectra of the blue, green and red emitters within the selected OLED microdisplay. A total of 21 lenslets in the MLA were sampled with each representing 9 element image points, which added up a total of 189 field samples. To evaluate the image quality, an ideal lens with the same power as the eyepiece is placed at the exit pupil of the system (viewing window), which resulted in a cut-off frequency of 20.83 lp/mm for the final image, limited by the pixel size of the microdisplay. The optical performance of the designed system was assessed at representative field angles for the three design wavelengths. By changing the power of the tunable lens VFE, the central depth plane could be shifted axially in a large range, for example, from 0 to 3 diopters, without noticeable degeneration of optical performance. FIGS. 8 through 10 plot the polychromatic modulation transfer function (MTF) for points reconstructed on the CDP set at the depth of 3, 1, and 0 diopters, respectively. For each CDP position, two sets of MTFs were plotted, one for fields corresponding to the on-axis MLA and one for fields correspond to the furthest MLA near the edge.

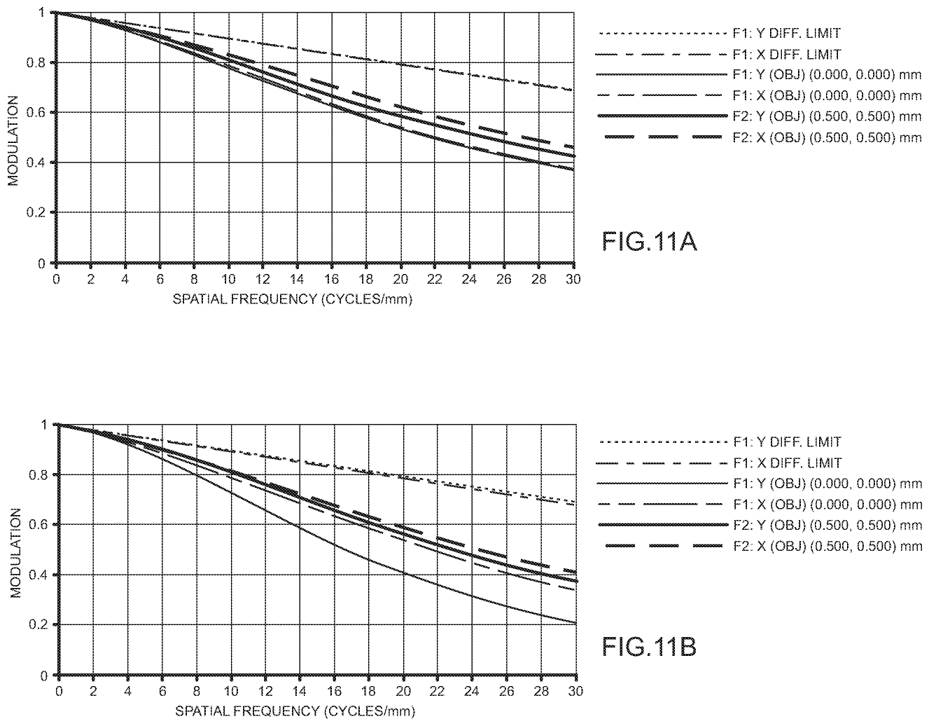

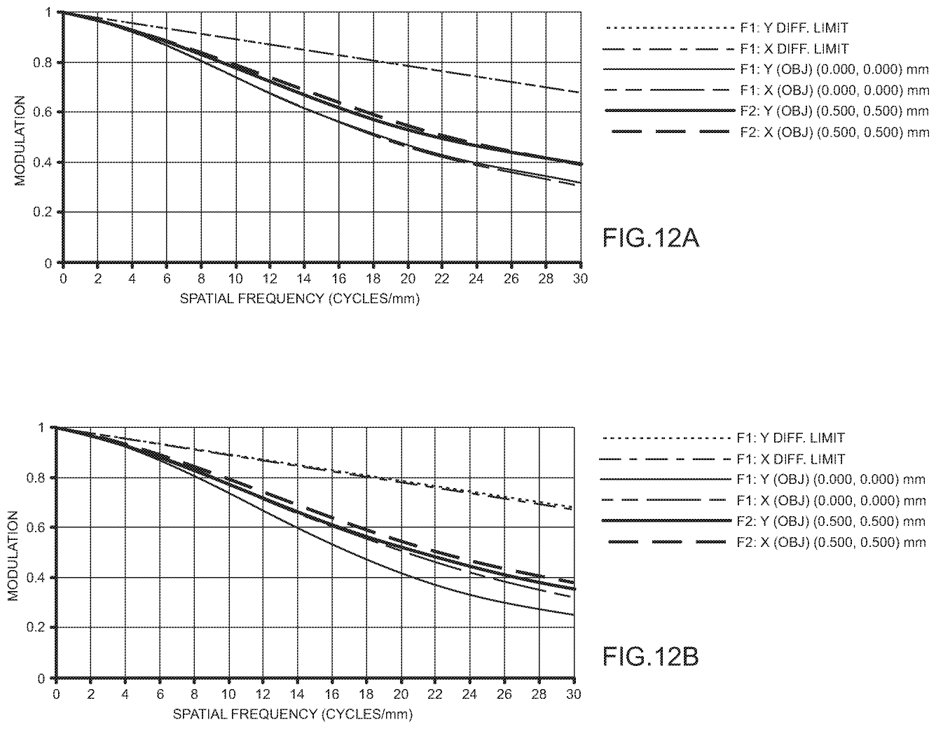

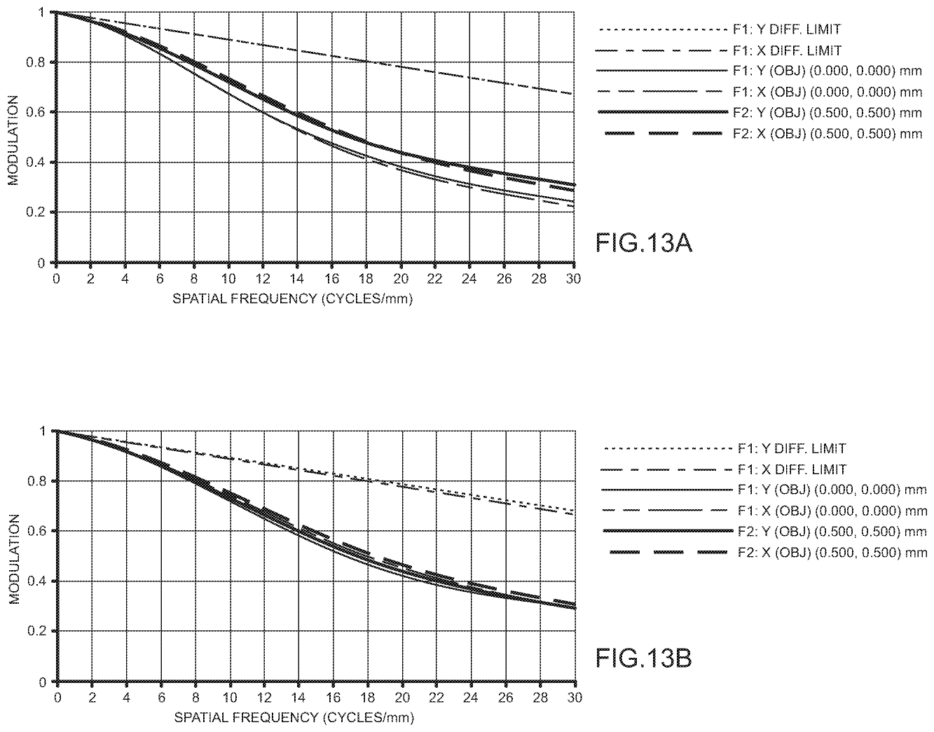

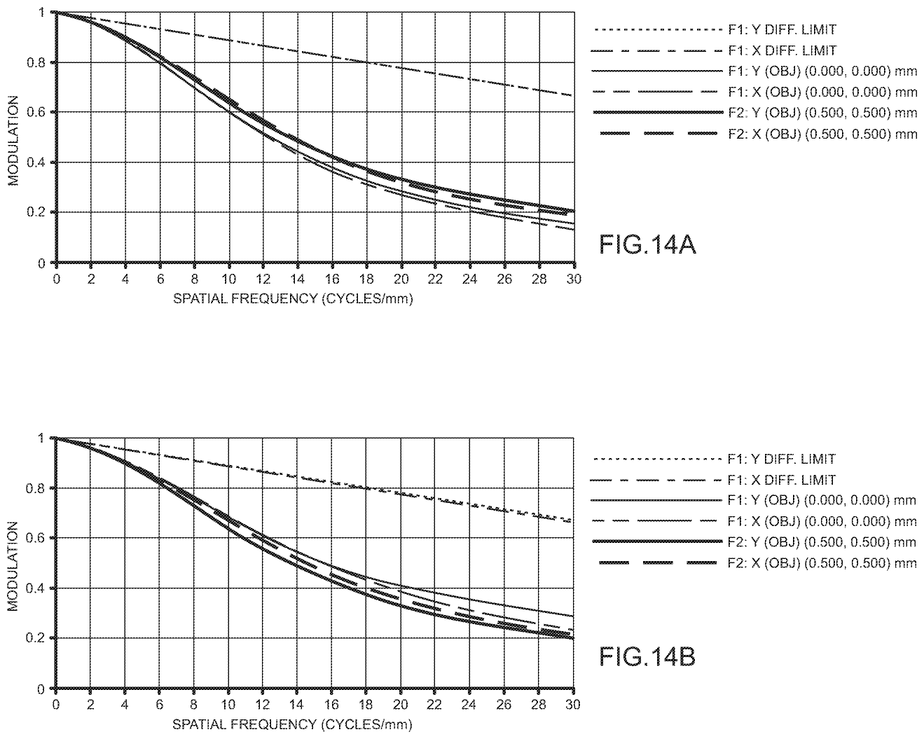

On the other hand, it is equally important to assess how the image quality of a 3D reconstruction point degrades when the reconstructed image is shifted away from the central depth plane for a specific tunable state. This can be evaluated by shifting the central depth plane a small amount of distance without changing the power of the tunable lens. FIGS. 11 through 14 plot the polychromatic MTF for reconstructed points shifted away from the CDP by 0.25, 0.5, 0.75, and 1 diopters, respectively. For each depth, two sets of MTFs were plotted, one for fields corresponding to the on-axis MLA and one for fields corresponding to the furthest MLA near the edge.

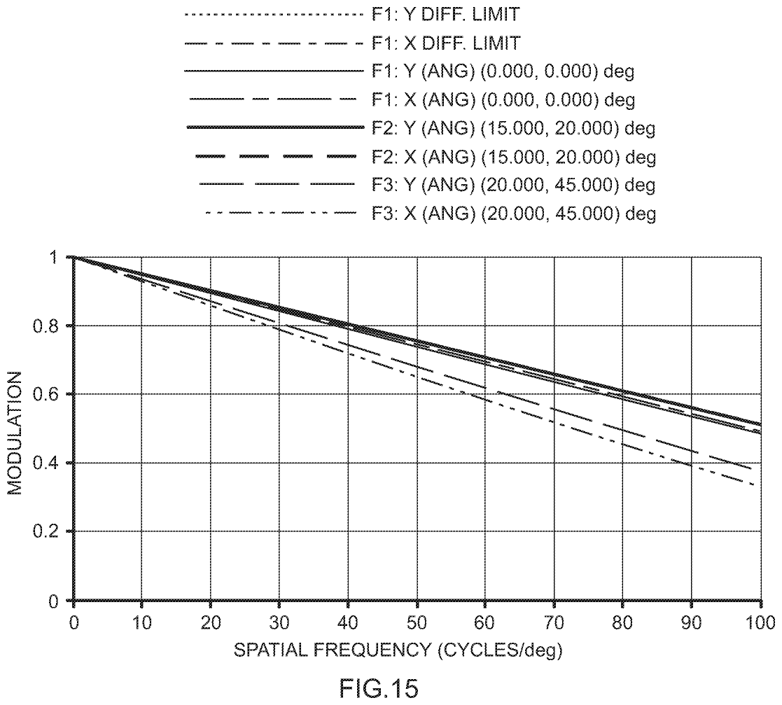

FIG. 15 plots the polychromatic MTF for the 65°×40° FOV. Across the entire the FOV, the see-through path achieved an average MTF value of over 50% at 30 cycles/degree frequency, corresponding to 20/20 normal vision, and nearly 20% at 60 cycles/degree frequency, corresponding to 20/10 vision or 0.5 arc minute of visual acuity.

What is claimed is:

1. A freeform waveguide prism, comprising:
a first freeform optical surface disposed to receive and refract light into the body of the prism;
a second freeform optical surface disposed to receive the refracted light from the first freeform optical surface and reflect the light into the body of the prism to provide an intermediate image within the body of the prism;
a compound freeform optical surface comprising:
an upper freeform optical surface connected to the second freeform optical surface and disposed such that light from the first freeform optical surface does not impinge thereon, and
a lower freeform optical surface connected to the upper freeform optical surface, with the upper freeform optical surface disposed between the lower and second freeform optical surfaces.

2. The freeform waveguide prism according to claim 1, comprising a third freeform optical surface disposed to receive the light from the intermediate image and total internally reflect the light into the body of the prism.

3. The freeform waveguide prism according to claim 2, wherein the lower freeform optical surface is disposed to receive the reflected light from the third freeform optical surface and reflect the light back to the third freeform surface at an angle that allows the light to exit the prism.

4. The freeform waveguide prism according to claim 2, wherein the upper freeform optical surface is disposed such that light from the third freeform optical surface does not impinge thereon.

5. The freeform waveguide prism according to claim 1, wherein slopes of the upper and lower freeform optical surfaces are equal at the location where such surfaces intersect.

6. The freeform waveguide prism according to claim 1, wherein the second freeform optical surface is configured to total internally reflect the light into the body of the prism.

7. The freeform waveguide prism according to claim 1, wherein the third freeform optical surface is configured to total internally reflect the light from the second freeform optical surface into the body of the prism.

8. The freeform waveguide prism according to claim 1, wherein the lower freeform optical surface is mirrored.

9. The freeform waveguide prism according to claim 1, wherein the lower freeform optical surface includes a beamsplitting coating.

10. The freeform waveguide prism according to claim 1, wherein for an orthogonal X-Y-Z coordinate system, the Z-axis is along the viewing direction, the Y-axis is parallel to the horizontal direction aligned with interpupilary direction of a user, and the X-axis is in the vertical direction aligning with the head orientation of the user.

11. The freeform waveguide prism according to claim 7, wherein the freeform waveguide prism is symmetric about the horizontal (Y-Z) plane.

12. The freeform waveguide prism according to claim 7, wherein the freeform optical surfaces are decentered along the horizontal Y-axis and rotated about the vertical X-axis.

13. The freeform waveguide prism according to claim 1, wherein the shape of any one of the freeform optical surfaces is given by
$$z = \frac{{cr}^{2}}{1 + \sqrt{1 - ( 1 + k ) {c}^{2} {r}^{2}}} + {\sum }_{j = 2}^{66} {C}_{j} {x}^{m} {y}^{n} j = \frac{{( m + n )}^{2} + m + 3 n}{2} + 1 ,$$
where z is the sag of the free-form surface measured along the z-axis of a local x, y, z coordinate system, c is the vertex curvature (CUY), r is the radial distance, k is the conic constant, and Cⱼ is the coefficient for x^{m}y^{m}.

14. A head-mounted display integral imaging (InI) system, comprising:
a microscopic InI unit (micro-InI) configured to create light fields of a selected 3D scene at a selected position along an optical axis of the system;
a relay unit having a vari-focal element (VFE) disposed therein, the relay unit disposed on the optical axis at a location so the selected position is an optical conjugate of the relay unit, the relay unit configured to receive the light fields created by the microscopic InI unit; and
the freeform waveguide prism according to claim 1 for receiving light from the relay unit to provide an image of the 3D scene at an exit pupil of the system for viewing by a user of the head-mounted display system,
wherein the VFE is configured to tune the location of the intermediate image within the body of the prism.

15. The head-mounted display integral imaging (InI) system of claim 14, wherein the microscopic InI unit (micro-InI) is configured to reproduce full-parallax light fields of a 3D scene having a constrained viewing zone.

16. The freeform waveguide prism or head-mounted display integral imaging (InI) system of claim 14, comprising a see-through unit in optical communication with the freeform waveguide prism to transmit a view of a real world to the freeform waveguide prism.

17. The freeform waveguide prism or head-mounted display integral imaging (InI) system of claim 16 wherein the see-through unit has a front surface that matches the shape of a rear surface of the freeform waveguide prism.

18. The head-mounted display integral imaging (InI) system of claim 14, wherein the relay unit comprises a first lens group and wherein the VFE is located at a back focal length of the first lens group.

19. The head-mounted display integral imaging (InI) system of claim 14, wherein the field of view of the system is independent of the optical power of the VFE.

20. The head-mounted display integral imaging (InI) system of claim 14, wherein the VFE is disposed on the optical axis at a location such that the compound optical power of the relay unit is maintained constant, independent of the optical power of the VFE.

21. The head-mounted display integral imaging (InI) system of claim 14, wherein the microscopic InI unit includes a microdisplay and the subtended field angle of the microdisplay through the freeform waveguide prism is maintained constant, independent of the optical power of the VFE.

22. The head-mounted display integral imaging (InI) system of claim 14, wherein the relay unit is configured to tune the position along the optical axis of the position of a reconstructed 3D virtual scene through the eyepiece by up to 5 diopters.

23. The head-mounted display integral imaging (InI) system of claim 14, wherein the focal range of the VFE is 75-100 mm.

24. The freeform waveguide prism or head-mounted display integral imaging (InI) system of claim 1, wherein the focal length of the freeform waveguide prism is 27.5 mm.

25. The head-mounted display integral imaging (InI) system of claim 14, wherein the diagonal field of view of the system is 35°.

26. The head-mounted display integral imaging (InI) system of claim 14, wherein the system has an optical resolution as high as 2 arc minutes per pixel.

27. The head-mounted display integral imaging (InI) system of claim 14, wherein the microscopic InI unit comprises a micro-lens array of which at least one lens surface is represented by the equation
$$z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} ,$$
where z is the sag of the surface measured along the z-axis of a local x, y, z coordinate system, c is the vertex curvature, r is the radial distance, k is the conic constant, A through E are the 4th, 6th, 8th, 10th and 12th order deformation coefficients, respectively.
